(19) United States
(12) Patent Application Publication
(10) Pub. No.: US 2026/0289271 A1
(43) Pub. Date: Sep. 24, 2026

(54) SYSTEM

(71) Applicant: SoftBank Group Corp., Tokyo (JP)

(72) Inventor: Han Yang SHEN, Tokyo (JP)

(73) Assignee: SoftBank Group Corp., Tokyo (JP)

(21) Appl. No.: 19/567,021

(22) Filed: Mar. 14, 2026

(30) Foreign Application Priority Data
Mar. 19, 2025 (JP) 2025-045220

(51) Int. Cl. G06N 3/0475; G06F 16/34; G06F 16/353; G06F 40/284; G06F 40/295

(52) U.S. Cl. CPC G06N 3/0475; G06F 16/345; G06F 16/353; G06F 40/284; G06F 40/295

(57) ABSTRACT

A system includes a processor, which is configured to: receive information from a user; analyze content of the received information by using a natural language processing technique and extract important words; sort the information to an appropriate department based on the extracted words; input a first prompt to a generative AI model to instruct detection of inappropriate expressions in the information in order to confirm whether the information includes an inappropriate expression; input a second prompt to the generative AI model to instruct generation of a summary in order to summarize a long text included in the information; analyze an emotional state of the user and set a priority of the information based on the emotional state; classify the information into an appropriate service based on an analysis result; and input a third prompt to the generative AI model to instruct classification and provision of feedback.

### CROSS-REFERENCE TO RELATED APPLICATION

This application is based on and claims priority under 35 USC 119 from Japanese Patent Application No. 2025-045220 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information handling systems that receive free-form text from users, such as inquiries, applications, or feedback, suffer from several limitations. First, such systems often rely on simple keyword matching or rule-based routing, which are insufficient to accurately understand the semantic content and context of the user's message. As a result, information is frequently misrouted to inappropriate departments or services, which increases processing time and degrades user satisfaction.

Second, existing systems typically lack effective mechanisms to automatically detect inappropriate expressions, such as abusive, offensive, or otherwise undesirable language, within the user's information. This absence of automated detection poses risks for compliance, brand protection, and user safety, and requires costly manual review.

Third, when users submit long texts, conventional systems do not efficiently summarize the content in a concise form that can be quickly understood by operators or downstream systems. Manual review of long text incurs substantial workload and delays, particularly in organizations handling a large volume of user submissions.

Fourth, many systems do not take into account the emotional state of the user reflected in the submitted information. Without emotion-aware prioritization, highly urgent or emotionally sensitive messages may be processed at the same priority as routine inquiries, thereby failing to provide adequate and timely responses to users in distress or in urgent need.

Fifth, even when some form of classification is implemented, conventional systems often lack integration with advanced generative AI models capable of performing nuanced classification and generating appropriate feedback. As a result, the system cannot automatically provide tailored, high-quality feedback or responses, and human operators must compose responses manually.

Accordingly, there is a need for a system capable of: (i) accurately analyzing user-submitted information using natural language processing, (ii) extracting important words and sorting the information to an appropriate department, (iii) detecting inappropriate expressions through interaction with a generative AI model, (iv) summarizing long texts, (v) analyzing the emotional state of the user to set a processing priority, and (vi) classifying the information to an appropriate service and providing feedback with the assistance of a generative AI model.

### SUMMARY

In order to solve at least part of the above-mentioned problems, a system according to one aspect of the present invention comprises a processor, wherein the processor is configured to receive information from a user, analyze content of the received information by using a natural language processing technique, and extract important words. By employing a natural language processing technique rather than simple keyword matching, the processor is capable of understanding the semantic content of the user's information and identifying words and expressions that are truly important for routing and understanding the message. The processor is further configured to sort the information to an appropriate department based on the extracted words. For example, the processor may associate particular patterns of extracted words with predefined department identifiers, and thus automatically determine a department that is most relevant to the content of the information. In this way, misrouting is reduced and processing efficiency is improved.

In addition, the processor is configured to input a first prompt to a generative AI model to instruct detection of inappropriate expressions in the information in order to confirm whether the information includes an inappropriate expression. By generating and inputting this first prompt, the processor leverages the generative AI model's capability to detect nuanced abusive, offensive, or otherwise undesirable language that may not be captured by static rule sets.

The processor is also configured to input a second prompt to the generative AI model to instruct generation of a summary in order to summarize a long text included in the information. When the length of the user's text exceeds a predetermined threshold, the processor causes the generative AI model to output a concise summary that preserves the essential content. This summary can then be used by human operators or downstream systems to quickly understand the main points of the information.

Furthermore, the processor is configured to analyze an emotional state of the user and to set a priority of the information based on the emotional state. The processor may employ an emotion analysis technique to infer, for example, whether the user is angry, distressed, satisfied, or neutral, and then assign a higher priority to emotionally urgent or critical messages. This enables preferential processing of information that may require immediate attention.

Moreover, the processor is configured to classify the information into an appropriate service based on an analysis result and to input a third prompt to the generative AI model to instruct classification and provision of feedback in order to provide feedback as needed. Using the analysis result and the response from the generative AI model, the processor can map the information to specific services or workflows and automatically generate or support generation of suitable feedback to the user.

According to this configuration, the system can automatically: (i) analyze user information with natural language processing, (ii) extract important words and route the information to an appropriate department, (iii) detect inappropriate expressions via a generative AI model, (iv) summarize long texts, (v) set information priority based on the user's emotional state, and (vi) classify the information to appropriate services and provide feedback with assistance from the generative AI model. Consequently, handling of user-submitted information becomes more accurate, efficient, and responsive to both content and emotional context.

The term “processor” refers to one or more hardware circuits, such as a central processing unit (CPU), graphics processing unit (GPU), application-specific integrated circuit (ASIC), programmable logic device, or a combination thereof, that execute instructions to perform the functions described in the claims.

The term “user” refers to a human operator or person who provides information to the system, for example by inputting text, inquiries, applications, or feedback through a user interface.

The term “information” refers to data provided by the user to the system, including but not limited to free-form text, structured text fields, inquiries, applications, feedback messages, or any other textual content to be processed by the processor.

The term “natural language processing technique” refers to any computational method or algorithm for processing and analyzing human language text, including but not limited to tokenization, morphological analysis, part-of-speech tagging, syntactic or semantic analysis, named-entity recognition, and other techniques for understanding or extracting meaning from text.

The term “important words” refers to words, phrases, or other linguistic units that are identified by the natural language processing technique as being particularly relevant to the meaning, topic, routing, classification, or prioritization of the information.

The term “department” refers to an organizational unit, function, team, or division within an entity, such as customer support, sales, technical support, legal, or any other internal or external organizational grouping to which information can be routed.

The term “sort the information to an appropriate department” refers to assigning or routing the information to one or more departments that are determined to be relevant to the content of the information, for example by generating a department identifier or forwarding the information to a corresponding processing queue.

The term “generative AI model” refers to a machine learning model, such as a large language model or other generative model, that has been trained on data to generate or transform text in response to an input prompt, and that is capable of performing tasks such as classification, detection of expressions, and summary generation.

The term “prompt” refers to input data provided to the generative AI model, including instructions, context, and the user's information or a representation thereof, which specify the task to be performed by the generative AI model.

The term “inappropriate expression” refers to language in the information that is undesirable for processing or display, including but not limited to offensive, abusive, hateful, threatening, obscene, or otherwise non-compliant expressions, as determined by a predetermined policy or rule set.

The term “summary” refers to a shortened representation of the original information that preserves the main points, essential meaning, or key elements of the information while omitting less important details.

The term “long text” refers to information whose length exceeds a predetermined threshold, such as a number of characters, words, or sentences, and that is deemed appropriate for summarization.

The term “emotional state of the user” refers to an inferred affective condition of the user, such as anger, frustration, sadness, distress, satisfaction, or neutrality, as determined from the content and/or style of the information using an emotion analysis technique.

The term “priority of the information” refers to a level or rank assigned to the information that indicates an order, urgency, or importance for processing, handling, or responding to the information.

The term “service” refers to a function, process, workflow, or system component that is configured to handle or respond to the information, such as a specific support service, advisory service, automated response service, or other operational function.

The term “classify the information into an appropriate service” refers to assigning the information to one or more services based on an analysis result, such that processing or response to the information is carried out by the selected service or services.

The term “feedback” refers to information provided back to the user in response to the user's information, including but not limited to acknowledgements, explanations, guidance, recommendations, or other response messages generated or assisted by the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

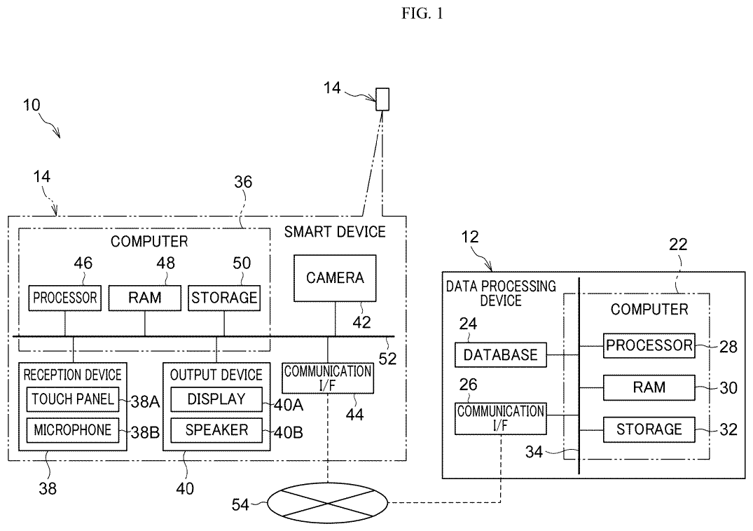

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

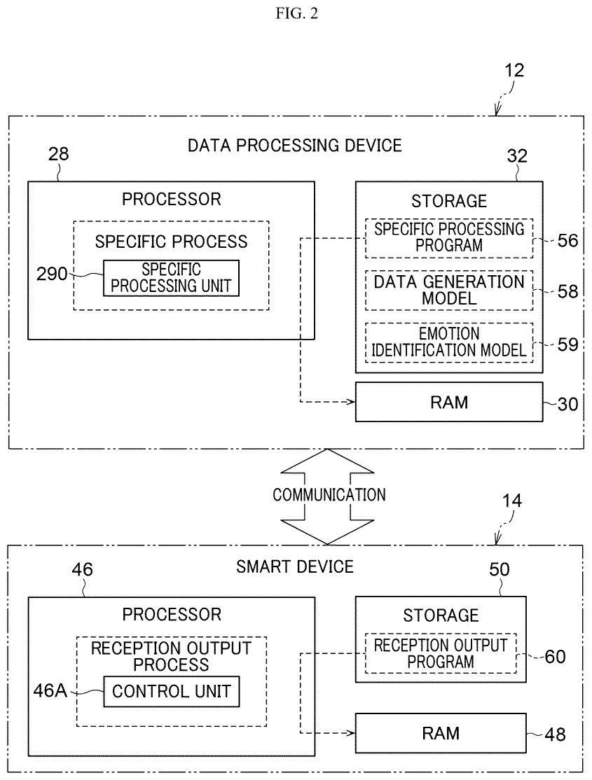

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that receive free-form natural-language input from users suffer from several technical limitations at the level of core computer processing. First, such systems typically apply rule-based or static natural-language processing pipelines that treat all incoming text uniformly, regardless of length, content, or urgency. As a result, server resources are inefficiently used: long texts are processed with the same shallow analysis as short texts, and summarization or deeper analysis is not selectively triggered in a manner that optimizes computation, latency, or memory usage.

Second, when content moderation or detection of inappropriate expressions is required, conventional systems rely either on fixed keyword lists or on monolithic classifiers tightly coupled to the application logic. These approaches make it difficult for the server to adapt its behavior to different types of incoming information or changing policies without substantial code changes. Furthermore, such systems are not designed to exploit generative AI models via prompt sentences in a systematic, programmable way that can be dynamically varied according to the context of each request.

Third, existing systems generally lack an integrated mechanism on the server side to jointly (i) evaluate user sentiment, (ii) set processing priorities, (iii) classify information into service categories, and (iv) coordinate these results with generative AI model calls. Typically, sentiment analysis, routing to departments or services, content moderation, and feedback generation are implemented as disconnected modules. This fragmented design leads to redundant parsing and analysis of the same text, increased processing overhead, higher memory consumption, and inconsistent or delayed responses to the user.

Fourth, when generative AI models are used, conventional systems often send raw user text with generic prompts, without dynamically constructing or switching prompt sentences based on the type of information, classification results, or emotional priority. This causes suboptimal use of the generative AI model, unnecessary token processing, and inconsistent output quality. Additionally, many systems do not return structured feedback that highlights specific problematic segments of the text to the user terminal, which requires extra post-processing or manual review and increases system load and response time.

Therefore, there is a need for an improved computer-implemented system and server-side processing method that: (i) automatically and efficiently determines, based on measurable properties of the input (such as length), whether advanced processing such as summarization should be invoked; (ii) integrates sentiment-based prioritization with classification and routing into services; (iii) programmatically constructs and dynamically changes prompt sentences for a generative AI model depending on context; and (iv) generates structured notification data, including warnings and summaries, in a single coordinated flow. Such a system should improve the technical performance of the server, including more efficient CPU and memory usage, reduced redundant processing, and reduced network and inference load toward the generative AI model, while providing faster and more consistent responses to the user terminal.

The specific processing by the specific processing unit 290 of the data processing device 12 in Example 1 is realized by the following means.

The present invention provides a server comprising a processor and a memory storing instructions which, when executed by the processor, cause the server to receive natural-language information transmitted from a user terminal; compute at least one of a character length and a word count of the information and determine, based on a computation result, whether the information is to be treated as a summarization target; analyze, by using natural-language processing, expressions included in the information and extract important terms and expressions corresponding to predetermined criteria; classify the information, based on the extracted expressions and contents of the information, into at least one of a functional category and a service category corresponding to an organizational unit or a processing service; generate a first prompt sentence including instruction content for confirmation of presence or absence of an inappropriate expression and the information, and input the first prompt sentence to a generative information processing apparatus so as to instruct a generative AI model, as the generative information processing apparatus, to detect the inappropriate expression; when it is determined that the information is the summarization target, generate a second prompt sentence including instruction content for summary generation and the information, and input the second prompt sentence to the generative AI model so as to instruct the generative AI model to generate a summary of a long text; analyze, based on contents of the information, an emotional state of a user and set a processing priority of the information according to an analysis result of the emotional state; automatically allocate the information, based on a classification result and the processing priority, to at least one of a processing service and a response service; generate a third prompt sentence including instruction content for classification and feedback provision and at least one of the information and the classification result, and input the third prompt sentence to the generative AI model so as to instruct the generative AI model to perform at least a validity evaluation of classification contents and generation of a feedback text for the user; and generate warning information and summary information to be notified to the user terminal, based on at least one of an analysis result, an inappropriate expression detection result, and a summary result acquired from the generative AI model, and transmit the warning information and the summary information to the user terminal. This enables a technical improvement of the computer system by orchestrating length-based control, sentiment-based prioritization, dynamic prompt sentence generation, classification, moderation, and summarization in a unified server-side pipeline, thereby reducing redundant processing, optimizing calls to the generative AI model, improving resource utilization, and providing faster, structured, and context-appropriate feedback to the user terminal.

The term “system” refers to an integrated combination of hardware and software components, including at least one server and at least one user terminal, that cooperatively execute information processing functions described in the claims.

The term “processor” refers to a hardware processing unit, such as a central processing unit or a graphics processing unit, that executes machine-readable instructions to perform the operations described in the claims.

The term “memory” refers to any non-transitory computer-readable storage medium, including volatile memory and non-volatile memory, that stores instructions and data for execution and use by the processor.

The term “user terminal” refers to an electronic device operated by a user, such as a computing device with a display and input interface, that transmits natural-language information to the server and receives notification data, warning information, and summary information from the server.

The term “natural-language information” refers to information expressed in a human language, represented as text data, that is input by a user and transmitted from the user terminal to the server.

The term “character length” refers to a quantitative measurement of the number of characters contained in the natural-language information.

The term “word count” refers to a quantitative measurement of the number of words contained in the natural-language information.

The term “summarization target” refers to natural-language information that satisfies predetermined conditions based on at least one of character length and word count and is therefore selected for summary generation.

The term “natural-language processing” refers to a set of computational techniques that analyze, interpret, and manipulate natural-language information, including tokenization, part-of-speech tagging, parsing, term extraction, sentiment analysis, and related operations.

The term “expression” refers to a contiguous sequence of characters or words within the natural-language information, including terms, phrases, and sentences, that can be analyzed by natural-language processing.

The term “important term” refers to an expression extracted from the natural-language information, based on predetermined criteria, that is considered to carry significant semantic or contextual meaning for classification, routing, or subsequent processing.

The term “predetermined criteria” refers to rules, thresholds, or models defined in advance, such as frequency thresholds, domain-specific lexicons, or statistical relevance measures, used to determine which expressions are to be extracted or how information is to be classified.

The term “functional category” refers to a classification label that represents a type of processing function or business function, such as inquiry handling, complaint processing, or support request handling, to which the natural-language information is to be routed.

The term “service category” refers to a classification label that represents a type of service or service area, such as technical support service or account management service, to which the natural-language information is to be allocated.

The term “organizational unit” refers to a logical or physical subdivision of an organization, such as a department or group, that is responsible for handling information classified into corresponding functional or service categories.

The term “processing service” refers to a server-side function or software module that performs automated handling of the natural-language information, such as automated analysis, registration, or workflow processing.

The term “response service” refers to a server-side function or software module that generates or manages responses to the user, including feedback messages, notifications, and replies based on processed information.

The term “generative information processing apparatus” refers to an information processing system, local or remote, that comprises a generative AI model and receives prompt sentences from the server to generate output based on the prompt sentences and the natural-language information.

The term “generative AI model” refers to a machine-learned model, such as a neural network model trained on large-scale data, that generates text output in response to input prompt sentences and natural-language information.

The term “prompt sentence” refers to an instruction text constructed by the server, including at least one of command content, conditions, and examples, and optionally including the natural-language information, which is provided as input to the generative AI model to control its output behavior.

The term “inappropriate expression” refers to an expression within the natural-language information that is determined to be socially unacceptable, offensive, discriminatory, or otherwise problematic according to predetermined policies or criteria.

The term “summary” refers to a condensed text that represents essential content of the natural-language information by focusing on main points and omitting less important details.

The term “long text” refers to natural-language information whose length, measured by at least one of character length and word count, exceeds a predetermined threshold and is therefore considered suitable for summarization.

The term “emotional state” refers to a state of user sentiment, such as positive, negative, neutral, or degrees thereof, inferred from the natural-language information using sentiment analysis or other emotion analysis techniques.

The term “processing priority” refers to a priority level assigned to the natural-language information, based on at least the emotional state and optionally other factors, which influences the order, speed, or resource allocation for processing the information.

The term “classification result” refers to information indicating one or more categories, such as functional categories or service categories, to which the natural-language information has been assigned by the server.

The term “validity evaluation of classification contents” refers to an assessment, performed by the generative AI model, regarding the appropriateness or correctness of the classification result assigned to the natural-language information.

The term “feedback text” refers to text generated for presentation to the user, which may include explanations, confirmations, suggestions, or other feedback related to the content or processing of the natural-language information.

The term “analysis result” refers to data generated by the server or the generative AI model, including at least one of extracted expressions, classification results, sentiment or emotional state analysis, and validity evaluations.

The term “inappropriate expression detection result” refers to a result indicating whether inappropriate expressions are present in the natural-language information and, if present, identifying corresponding portions or expressions.

The term “summary result” refers to a result that includes the generated summary of the natural-language information output by the generative AI model.

The term “warning information” refers to information generated by the server for notification to the user terminal, indicating at least a presence of inappropriate expressions or strongly negative content and optionally including guidance or recommendations for revision.

The term “summary information” refers to information generated by the server for notification to the user terminal, including at least the summary result and optionally additional metadata related to the summarization.

The term “notification data” refers to data generated by the server for transmission to the user terminal, including at least one of warning information, summary information, emphasis display information, and correction candidate information.

The term “emphasis display” refers to a display mode on the user terminal in which specific portions of the natural-language information, such as inappropriate expressions, are visually highlighted using distinct formatting or markers.

The term “correction candidates” refers to alternative expressions or suggested modifications for replacing or revising inappropriate expressions or otherwise problematic portions of the natural-language information.

The term “dynamic change of the prompt sentence” refers to a modification of content or structure of a prompt sentence performed by the server at runtime, based on context such as information type, classification result, or processing priority, before the prompt sentence is input to the generative AI model.

The term “instruction content” refers to explicit directions contained in a prompt sentence, which specify tasks for the generative AI model, such as detection of inappropriate expressions, generation of a summary, evaluation of classification validity, or generation of feedback text.

The term “information type” refers to a category or attribute of the natural-language information, such as inquiry, complaint, opinion, or request, determined by the server or by analysis results.

The term “context-appropriate feedback” refers to feedback text and notification data whose content and level of detail are adjusted based on the classification result, emotional state, processing priority, or other contextual factors associated with the natural-language information.

In one embodiment, a server cooperates with at least one terminal operated by a user to implement a system that processes natural-language information by using a generative AI model. The server includes at least one processor and at least one memory storing instructions, and is connected to a network interface. The terminal includes at least one processor, a memory, a display, and an input device such as a keyboard or a touch panel, and executes a web browser or a native application.

The server runs an operating system such as a server-class operating system and executes an application program implemented, for example, using a web framework (such as a general-purpose HTTP server framework) and a programming language (such as a general-purpose scripting or compiled language). The server further communicates with a database management system such as a relational database engine to store and retrieve records representing user input, analysis results, and generated summaries. The server accesses a generative AI model deployed either as a cloud-based inference service or as an on-premise inference engine running on a machine equipped with a graphics processing unit.

The server stores in memory data structures that represent user information in a structured format. In one configuration, the server stores each piece of natural-language information as a record having fields such as: a unique request identifier, a user identifier, a timestamp, an input_text string, a length_value (character length and/or word count), a boolean flag indicating whether the text is a summarization target, a classification_result indicating at least one functional category and/or service category, an emotional_state label, a processing priority value, an inappropriate_expression_list, a keyword_list, a summary_text field, and a feedback_text field. The server uses these data structures to avoid redundant parsing and to coordinate subsequent processing stages.

The server uses natural-language processing software libraries, such as tokenization libraries and part-of-speech taggers, to analyze the text received from the terminal. The server converts the input_text into a sequence of tokens and computes statistics such as token count and character length. Based on these values, the server sets the summarization flag. For example, the server treats the information as a summarization target when the token count exceeds a predetermined threshold (for example, 200 tokens). The server writes this decision into the corresponding record, which allows later modules to check the summarization flag without re-computing the length.

The server analyzes the text using a feature extraction pipeline. The server applies tokenization, part-of-speech tagging, and syntactic chunking to identify candidate expressions. The server then applies a scoring algorithm such as term frequency-inverse document frequency or a learned importance score to extract important terms. The server identifies expressions that match predetermined patterns or lexicons corresponding to certain domains (for example, “support,” “billing,” or “performance”), and stores those expressions and their types into a keyword_list associated with the record. This structured extraction enables the server to perform category classification without re-parsing the raw text.

The server classifies the information into at least one functional category and/or service category by applying a classification algorithm such as a statistical classifier or a neural-network-based classifier that uses the extracted features. For example, the server uses a feedforward neural network with embedding layers that receive token embeddings of important terms, and hidden layers that output probabilities over a set of categories such as “technical support,” “account issue,” or “general feedback.” The server selects the category (or categories) whose probability exceeds a predetermined threshold, and stores the classification_result in the record.

The server computes an emotional_state of the user by applying a sentiment analysis model. In one implementation, the server uses a recurrent neural network or a transformer-based classifier, which receives as input the tokenized text and outputs a sentiment class such as “highly negative,” “negative,” “neutral,” “positive,” or “highly positive,” optionally with a confidence score. The server maps the sentiment class and the confidence score to a processing_priority value, for example by assigning higher priority to “highly negative” texts that may indicate urgent issues. The server stores both the emotional state and processing priority in the record so that scheduling and routing modules can use these values. The server uses these structured results to determine how to interact with the generative AI model. The server generates one or more prompt sentences that instruct the generative AI model to perform specific tasks. The server constructs each prompt sentence by concatenating template instruction text with the actual user input_text and, where applicable, with intermediate results such as the classification result. The server stores the generated prompt sentences in the record to maintain traceability and to allow later auditing of the AI interactions.

In one example, the server generates a prompt sentence for moderation and keyword extraction as follows:

“Please analyze the following user input.

1. List any inappropriate expressions or socially unacceptable phrases.

2. List any specific keywords related to support, price, or quality.

3. Output the result in a clear and structured way.

Text: ‘This product is very good, but the support is slow.’”

In another example, when the summarization flag is set, the server generates a prompt sentence for summarization as follows:

“Please summarize the following user feedback in one or two sentences.

Focus on the main positive points and the main negative points.

Output only the summary sentence.

Text: ‘This product is very good, but the support is slow and sometimes unhelpful. I like the design and the battery life, but I am not satisfied with the response time of the support team.’”

In yet another example, the server generates a prompt sentence for validation of classification and feedback generation as follows:

“You are an assistant that checks routing decisions and creates user-facing feedback.

Given the following text and its assigned category,

1. Confirm whether the category is appropriate.

2. If it is not appropriate, suggest a better category.

3. Generate a short feedback message to the user explaining how the request will be handled.

Text: ‘I cannot log into my account and I get an error message.’

Assigned category: ‘technical support’.”

The server sends these prompt sentences to the generative AI model via a programmatic interface such as an HTTPS-based API. When the generative AI model is deployed on a separate machine, the server communicates over a network using a defined protocol. When the generative AI model is deployed locally, the server invokes a local inference engine that executes the model using a neural network framework. The generative AI model is, for example, a transformer-based neural network trained on large-scale text data, with multiple self-attention layers and feed-forward layers. The model uses an embedding layer to convert tokens to vectors, applies positional encoding, and processes the sequence through stacked attention blocks. The model computes the next token probabilities using a softmax layer over a vocabulary, and generates text outputs token by token until an end condition is met. The server configures the generative AI model with specific inference parameters for each type of prompt sentence. For detection of inappropriate expressions, the server sets parameters (such as low randomness) to encourage deterministic and reproducible outputs. For summarization, the server allows slightly higher creativity (such as a higher randomness value) to improve readability while preserving the main meaning. The server thus controls the behavior of the model programmatically, which differs from static human-written text processing because it uses parameterized instructions and adaptive inference settings. The server processes responses from the generative AI model by parsing and normalizing the returned text. When the generative AI model outputs lists of inappropriate expressions and keywords, the server applies string matching and regular-expression processing to map the reported expressions back to character positions in the original input_text. The server stores these mappings in a data structure that associates each inappropriate expression with its start and end index, its type, and a severity level (if provided). The server then generates notification data that indicates which portions of the text should be emphasized or replaced, and which alternative expressions are suggested, if any.

The terminal receives this notification data, and, using client-side application logic (for example, JavaScript in a browser-based implementation), the terminal highlights the corresponding character ranges in the displayed text by enclosing them in markup that triggers visual emphasis such as underlining or color change. The terminal may additionally display proposed corrections adjacent to the highlighted text. This user interface behavior is directly determined by the structured data computed by the server, enabling consistent rendering without manual interpretation.

The server uses the classification_result and processing_priority to allocate the information to internal processing services or response services. For example, the server maintains routing rules in a configuration table, which maps combinations of categories and priority levels to processing queues or service endpoints. The server inserts a job into a queue that is processed by a specific service module, and embeds the analysis results and AI outputs in the job payload. Because the server manages these queues using priority scheduling, high-priority messages are processed with shorter latency. This architecture reduces average response time for urgent cases and makes better use of processor and memory resources by not treating all messages equally.

The server dynamically changes prompt sentences based on the context of each request. When the server identifies that the text relates to a particular service category, the server selects a category-specific prompt template. For instance, in a technical issue category, the server emphasizes error codes and device information in the prompt, while in a billing issue category, the server emphasizes time periods and amounts. The server may also shorten or omit certain parts of the input when the classification_result and keyword_list indicate that only a subset of the content is relevant for the desired AI operation. By doing this, the server reduces the number of tokens sent to the generative AI model, thereby decreasing computation time and communication bandwidth usage.

In one embodiment, the server precomputes and caches intermediate representations, such as token sequences or embedding vectors, to avoid re-tokenizing the same text when constructing multiple prompt sentences. The server can reuse these intermediate results when performing sentiment analysis, classification, and generation of AI prompts. This design improves computational efficiency because tokenization and encoding are typically expensive operations. The server may store these intermediate representations transiently in memory, keyed by the request identifier, and discard them when they are no longer needed, thereby balancing performance and memory usage.

The generative AI model itself is trained offline using a large corpus of text data. The training process uses a loss function such as cross-entropy over the predicted token distribution, and a gradient-based optimization method such as stochastic gradient descent with adaptive learning rate. During training, the model learns to generate coherent text that follows instructions embedded in prompt sentences. In some embodiments, the model undergoes additional fine-tuning on domain-specific data that includes examples of moderation, summarization, classification validation, and feedback generation. This fine-tuning process uses supervised learning, where pairs of input prompt sentences and desired outputs are provided, and the model weights are updated to minimize the difference between the generated outputs and the target outputs. In other embodiments, reinforcement learning from human feedback is used to adjust the model's responses to align with quality and safety criteria.

The server leverages these trained capabilities by designing non-conventional prompt sentences and processing flows that are specifically tailored to improve computer performance. Unlike a simple automation of human review, the server uses internal routing logic, priority scheduling, dynamic prompt construction, and token-level highlighting to create a coordinated, multi-step pipeline that is difficult to reproduce manually. For example, human reviewers cannot efficiently compute character-level mappings and maintain synchronized data structures for highlighting and routing across thousands of concurrent requests, whereas the server can perform these operations in parallel with low error rate. The technical effect of this architecture is multifold. The server reduces redundant text processing by storing and reusing intermediate analysis results. The server decreases the average number of tokens sent to the generative AI model by applying length-based thresholds and context-based prompt selection, which reduces inference time and network traffic. The server improves accuracy and consistency of content moderation and routing by combining deterministic natural-language processing modules (such as tokenization and classification) with generative AI outputs that are guided by carefully structured prompt sentences. The server also improves data management by maintaining unified records that hold all information related to a single user request, including AI analysis results, which simplifies logging and auditing.

The system achieves improved processing speed because the server avoids unnecessary calls to the generative AI model for short texts that do not require summarization, and because the server uses processing priority to schedule tasks such that time-sensitive cases are handled promptly. The server achieves reduced error rates in classification and moderation by using the generative AI model to cross-check or refine the outputs of traditional classifiers. The system also reduces communication load by dynamically trimming irrelevant text segments in prompt sentences and by selecting appropriate instruction content that yields compact, task-specific outputs from the generative AI model.

In a variation of the embodiment, the server uses different generative AI models for different tasks, such as one model optimized for moderation and another for summarization. The server selects which model to invoke based on the classification result and processing_priority, and stores this selection in the record. In another variation, the server executes the generative AI model on-premise on GPU hardware, while in yet another variation, the server calls a managed inference service over the network. In both cases, the logical flow of constructing prompt sentences, sending them for inference, and processing responses remains the same.

In another embodiment, the terminal is not a browser-based device but a native mobile application or a desktop application. The terminal still transmits natural-language information and receives structured notification data, and the server still performs the described analysis and AI interactions. The differences lie mainly in the user interface implementation, while the server-side processing, data structures, and technical advantages remain applicable.

Through these embodiments and variations, the server, terminal, and user cooperate to implement a system where a generative AI model is controlled by dynamically generated prompt sentences, internal classification and sentiment analysis, and structured data flows. This system improves the functioning of the computer infrastructure itself by managing resources more efficiently, reducing redundant computation, and enabling accurate, fast, and context-appropriate processing of natural-language information.

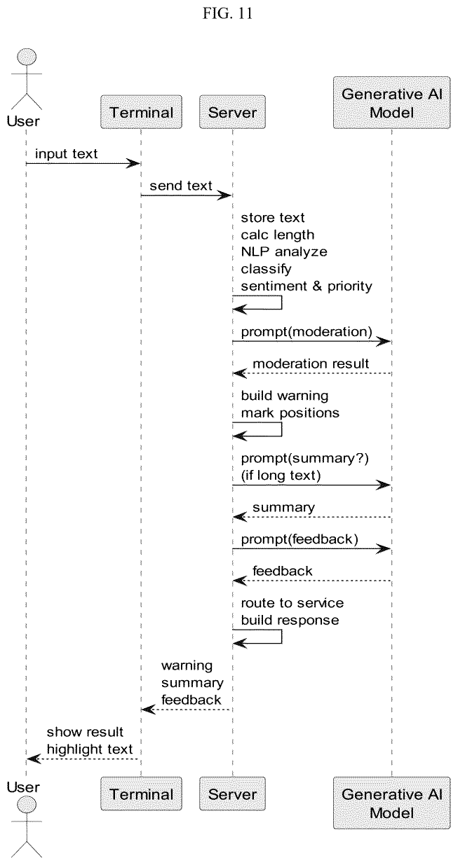

The following describes the processing flow using FIG. 11.

### Step 1:

The user operates the terminal to input natural-language text.

The terminal displays an input screen using a web browser or an application, and the user types free-form text such as feedback, inquiries, or complaints into a text area or input field.

Input: The user's keystrokes and touch operations on the terminal.

Output: A text string displayed in the input field on the terminal.

### Step 2:

The terminal transmits the input text to the server.

The terminal reads the text string from the input field, encapsulates the text in a request payload (for example, a JSON object with a field for the text), and sends the payload to the server over a network using an HTTP or HTTPS request.

Input: The text string present in the terminal's memory.

Output: A network message containing the text string transmitted to the server.

### Step 3:

The server receives and records the input text.

The server accepts the network message, parses the payload to extract the text string, and creates a new record in a data store, associating the text with a unique identifier, a timestamp, and optional user information. The server writes these values into structured fields of the record.

Input: The network message with the text string and associated metadata.

Output: A stored record containing at least an input_text field and a unique request identifier.

### Step 4:

The server computes length information and determines whether summarization is required.

The server reads the input_text from the record, counts either characters or words (or both), and compares the count to a predetermined threshold. The server sets a summarization_flag in the record to indicate whether the text should be treated as a summarization target.

Input: The input_text field stored in the record.

Output: A numerical length_value and a summarization_flag stored in the record.

### Step 5:

The server analyzes the text using natural-language processing to extract expressions and important terms.

The server tokenizes the input_text into tokens, applies part-of-speech tagging or chunking, and identifies candidate phrases. The server computes scores such as term importance or domain relevance and selects expressions whose scores exceed a threshold. The selected expressions are stored as an important_terms list.

Input: The input_text field from the record.

Output: A list of important terms and expressions associated with the record.

### Step 6:

The server classifies the information into functional and service categories.

The server feeds the extracted important terms and text features into a classification module, which may be implemented using a machine-learning classifier. The server obtains probability scores for each category and selects one or more categories whose probabilities exceed category-specific thresholds. The server writes these categories into a classification result field.

Input: The important_terms list and derived features from the input_text.

Output: A classification_result indicating at least one functional category and/or service category.

### Step 7:

The server analyzes the user's emotional state and sets a processing priority.

The server passes the tokenized input_text to a sentiment analysis component, which computes sentiment scores (for example, negative, neutral, positive) and optionally an intensity measure. The server maps the sentiment outcome to a discrete emotional state label and then to a processing_priority value, and stores both in the record.

Input: The tokenized representation of the input_text.

Output: An emotional_state label and a processing_priority value stored in the record.

### Step 8:

The server constructs a prompt sentence for inappropriate expression detection and keyword analysis.

The server selects a prompt template for moderation, embeds the input_text into the template, and forms an instruction such as:

“Please analyze the following user input.

1. List any inappropriate expressions or socially unacceptable phrases.

2. List any specific keywords related to support, price, or quality.

3. Output the result in a clear and structured way.

Text: ‘[input_text]’.”

The server records the generated prompt sentence as a moderation_prompt in the record.

Input: The input_text and predefined prompt template for moderation.

Output: A moderation prompt sentence stored in the record.

### Step 9:

The server sends the moderation prompt sentence to the generative AI model.

The server creates a request to an inference interface, embeds the moderation_prompt as the content of the request, and transmits the request over a network or an internal interface to the generative AI model. The server sets inference parameters appropriate for deterministic moderation (for example, low randomness).

Input: The moderation prompt sentence and inference parameters.

Output: A model request message transmitted to the generative AI model.

### Step 10:

The server receives and interprets the moderation result from the generative AI model.

The server obtains a response containing text that describes detected inappropriate expressions and related keywords. The server parses the response, separates reported expressions and keywords, and constructs lists for inappropriate_expression_list and keyword_list. The server also maps each reported expression to its position in the original input_text by performing substring searches or token alignment.

Input: The moderation response text from the generative AI model.

Output: Structured lists for inappropriate_expression_list and keyword_list, and position mappings stored in the record.

### Step 11:

The server determines whether to generate warning information based on the detected expressions.

The server checks whether inappropriate_expression_list is empty. If it is not empty, the server creates a warning_message that references the problematic portions, using the stored position mappings to identify exact substrings. If it is empty, the server sets warning_message to indicate no issues.

Input: The inappropriate_expression_list and position mappings.

Output: A warning_message field that either contains a warning description or indicates absence of inappropriate expressions.

### Step 12:

The server constructs a prompt sentence for summarization when summarization is required. When the summarization flag indicates that the text is a summarization target, the server selects a summarization template, inserts the input_text, and forms an instruction such as: “Please summarize the following user feedback in one or two sentences.

Focus on the main positive points and the main negative points.

Output only the summary sentence.

Text: ‘[input_text]’.”

The server stores this as a summarization prompt in the record.

Input: The input_text and the summarization_flag.

Output: A summarization prompt sentence stored in the record when summarization is required.

### Step 13:

The server sends the summarization prompt sentence to the generative AI model.

The server packages the summarization_prompt with suitable inference parameters and transmits it to the generative AI model over the selected interface.

Input: The summarization prompt sentence and summarization inference parameters. Output: A model request message for summarization transmitted to the generative AI model.

### Step 14:

The server receives and records the summary result from the generative AI model.

The server obtains a response containing a summary sentence or a small number of sentences.

The server writes this summary_text into the corresponding field in the record.

Input: The summary response text from the generative AI model.

Output: A summary_text field stored in the record.

### Step 15:

The server constructs a prompt sentence for classification validation and feedback generation.

The server selects a validation-and-feedback template, incorporates the input_text and the classification_result, and generates an instruction such as:

“You are an assistant that checks routing decisions and creates user-facing feedback.

Given the following text and its assigned category,

1. Confirm whether the category is appropriate.

2. If it is not appropriate, suggest a better category.

3. Generate a short feedback message to the user explaining how the request will be handled.

Text: ‘[input_text]’

Assigned category: ‘[classification_result]’.”

The server stores this as a feedback prompt in the record.

Input: The input_text and the classification result.

Output: A feedback_prompt sentence stored in the record.

### Step 16:

The server sends the feedback prompt sentence to the generative AI model and receives a feedback result.

The server transmits the feedback prompt to the generative AI model and obtains a response that includes an evaluation of the classification and a candidate feedback message. The server parses the response, updates the classification result if a better category is suggested, and stores the feedback_text in the record.

Input: The feedback_prompt sentence and the model's response text.

Output: Possibly updated classification_result and a feedback_text field stored in the record.

### Step 17:

The server allocates the information to processing and response services based on classification and priority.

The server reads classification_result and processing_priority from the record, consults routing rules, and determines which processing queue or service endpoint should handle the request. The server creates a job entry that contains references to the record and places the job into the selected queue.

Input: The classification_result and processing priority values.

Output: A queued job or routing directive linking the request to a specific processing or response service.

### Step 18:

The server composes notification data including warnings, summaries, and feedback for the terminal.

The server gathers warning_message, summary_text, and feedback_text from the record, along with optional highlighting information derived from inappropriate_expression_list. The server assembles these into a response structure that specifies what should be displayed and how problematic segments should be emphasized.

Input: The warning_message, summary_text, feedback_text, and position mappings.

Output: Notification data prepared for transmission to the terminal.

### Step 19:

The server transmits the notification data to the terminal.

The server converts the notification data into a response message and sends it back to the terminal over the network.

Input: The composed notification data structure.

Output: A network response message delivered to the terminal.

### Step 20:

The terminal updates its display based on the notification data.

The terminal receives the response, interprets the warning_message, summary_text, feedback_text, and highlighting information, and updates the user interface. The terminal highlights specific portions of the original text, shows the summary in a dedicated area, and presents any feedback message or warning to the user.

Input: The notification data received from the server.

Output: Updated screen content on the terminal that presents highlighted text, summary, and feedback to the user.

### Step 21:

The user reviews the highlighted text and generated feedback and optionally modifies the input.

The user observes which expressions are marked as inappropriate, reads the summary and feedback, and decides whether to revise the original text. The user may edit the text in the input field and resubmit it, causing the processing flow from Step 2 onward to be repeated with the updated input.

Input: The visual display of the highlighted text, summary, and feedback on the terminal.

Output: A revised text string entered by the user, which can be sent again to the server for further processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic information processing systems that receive user-entered text, such as in payment workflows or service inquiry workflows, typically perform only rule-based validation, simple keyword filtering, and static routing. Such systems rely on predetermined pattern matching or manually configured lists of prohibited expressions, and therefore cannot robustly handle diverse natural language inputs, nuanced inappropriate expressions, or context-dependent errors in real time. Furthermore, existing architectures generally separate input validation, content moderation, text summarization, emotional analysis, and service routing into independent modules that do not share analysis results or adaptively cooperate. As a result, system resources are not efficiently utilized, latency is increased by redundant processing, and the user experience is degraded by delayed or inconsistent feedback.

In particular, when users input free-form text including comments or explanations, the system often fails to promptly detect inappropriate expressions or obviously erroneous information, and cannot provide targeted feedback to guide the user to correct the input. At the same time, when the user submits long text, the system has difficulty generating concise summaries that can be used both for user confirmation and for internal routing, without manually crafted domain-specific logic. Existing systems also provide only coarse or static priority control and do not adjust processing order or prompt content based on a dynamically inferred emotional state of the user, which leads to suboptimal allocation of computational and support resources, especially under heavy load.

From a computer technology standpoint, there is a need for an improved architecture and processing flow that integrate a natural language processing engine with a generative artificial intelligence model through structured prompt sentences, such that (i) text normalization, analysis, and routing are coordinated with (ii) model-based detection of inappropriate expressions and erroneous information, (iii) model-based summarization of long text, and (iv) emotion-aware priority control and feedback generation. Without such an integrated and adaptive control mechanism, servers cannot efficiently reuse inference results, cannot dynamically modify prompts or routing decisions, and cannot realize stable, low-latency, real-time interaction with terminals. Consequently, the technical problem addressed by the present invention is to improve the functioning of a computer system that processes user-entered text by providing a coordinated server-side control scheme that reduces redundant computation, structures the interaction with a generative AI model, and enhances real-time responsiveness and reliability of validation, moderation, summarization, and routing operations.

The specific processing by the specific processing unit 290 of the data processing device 12 in Application Example 1 is realized by the following means.

The present invention provides a server comprising a processor configured to receive, via a communication interface, text data input by a user from a terminal, to preprocess character strings included in the text data by using a natural language processing technique including character code normalization, whitespace removal, and format unification, to analyze contents of the text data by the natural language processing technique so as to extract important terms and determine whether the text data is long text based on at least one of a character count and a token count, to automatically route the text data to one of a plurality of processing categories or service divisions based on the extracted important terms and analysis results, to generate a first prompt sentence describing an analysis request including the text data as an instruction for detecting inappropriate expressions or erroneous information and to input the first prompt sentence to a generative artificial intelligence model, to obtain, from the generative artificial intelligence model, response data indicating at least one of presence or absence of an inappropriate expression, a specific example of the inappropriate expression, and an analysis result regarding information suspected to be an erroneous input, to identify a problematic portion in the text data based on the response data, and to transmit warning information corresponding to the problematic portion to the terminal, to generate, when the text data is determined to be long text, a second prompt sentence describing an instruction for generating a summary, to input the second prompt sentence and the text data to the generative artificial intelligence model to obtain summary text, and to transmit the obtained summary text to the terminal, to analyze an emotional state of the user based on expressions and terms extracted from the text data and set a processing priority of the text data in accordance with the emotional state, to classify the text data into one of a plurality of service types based on at least one of the analysis results and the processing priority, to generate a third prompt sentence describing an instruction for generating feedback information including at least one of a guidance message and a correction candidate and to input the third prompt sentence to the generative artificial intelligence model, to provide obtained feedback information to the terminal in real time, and to perform control to repeatedly execute a series of processing including analysis, inappropriate expression detection, summary generation, priority setting, and feedback provision on corrected text data transmitted from the terminal. This enables an improvement in computer functionality by coordinating natural language preprocessing with structured prompt-based interaction with the generative artificial intelligence model, thereby reducing redundant computations across validation, moderation, summarization, and routing tasks, dynamically adapting prompts and processing order to user emotional state, and achieving low-latency, real-time feedback and more reliable automated handling of user-entered text within the server-implemented information processing system.

The term “processor” refers to a hardware-based or virtual computation unit, such as a central processing unit, graphics processing unit, or dedicated processing circuitry, that executes instructions to perform operations including text reception, analysis, routing, prompt generation, model interaction, and control of communication with a terminal.

The term “terminal” refers to an endpoint computing device, such as a mobile device, personal computer, or embedded device, operated by a user and configured to transmit text data to a server and to receive and display warning information, summary text, and feedback information.

The term “communication unit” refers to a hardware and software communication interface, such as a network interface controller and associated protocol stack, that enables data exchange between the server and one or more terminals over a communication network.

The term “text data” refers to information composed of one or more character strings, including but not limited to natural language sentences, symbols, and numerals, that is input by a user and transmitted from a terminal to the server.

The term “natural language processing technique” refers to a computational method or set of algorithms that operate on human language text, including at least one of tokenization, part-of-speech tagging, parsing, named entity recognition, sentiment analysis, and other linguistic or semantic analysis processes.

The term “character code normalization” refers to a process of converting character data into a standardized encoding and representation, including unifying different but equivalent character forms so that text data can be consistently analyzed and compared.

The term “whitespace removal” refers to a process of removing or reducing space characters, tab characters, line breaks, or other non-printing spacing symbols from text data, except where retention is necessary for semantic or structural reasons.

The term “format unification” refers to a process of standardizing the structural representation of text data, including at least one of normalizing punctuation, unifying date or number formats, and adjusting line breaks or indentation to a predefined rule set.

The term “analysis result” refers to information derived from processing of the text data by the natural language processing technique or the generative artificial intelligence model, including but not limited to extracted terms, detected expressions, classification labels, and priority scores.

The term “important terms” refers to words, phrases, or tokens extracted from text data that are determined, by a natural language processing technique, to be salient for tasks such as routing, classification, or emotion analysis.

The term “long text” refers to text data whose length, measured by at least one of character count and token count, exceeds a predetermined threshold such that summarization or special handling is desirable.

The term “processing category” refers to a logical grouping for internal handling of text data within the server, indicating a type of operation or workflow to which the text data is to be routed.

The term “business division” refers to an organizational unit or functional area within a service provider or system operator that is responsible for handling a specific type of user request or information.

The term “service type” refers to a classification category that represents a kind of service, transaction, or support process associated with the text data processed by the server.

The term “routing” refers to a process of assigning text data to at least one of a processing category, business division, or service type based on analysis results and extracted important terms.

The term “inappropriate expression” refers to a word, phrase, or textual content that is determined to be offensive, discriminatory, abusive, in violation of a policy, or otherwise unsuitable for the intended service or social standards.

The term “erroneous information” refers to part of text data that is suspected to be incorrect, inconsistent, malformed, or intentionally false in the context of the associated service or transaction.

The term “generative artificial intelligence model” refers to a machine learning model trained to generate or transform natural language text, including models based on neural network architectures, that can produce analysis results, summaries, and feedback information in response to prompt sentences.

The term “prompt sentence” refers to an instruction or query in natural language or structured text that is provided as input to a generative artificial intelligence model to cause the model to perform a specified task such as analysis, detection, summarization, or feedback generation.

The term “response data” refers to output information generated by the generative artificial intelligence model in response to a prompt sentence, including analysis results, detected expressions, suggested warnings, summaries, or feedback content.

The term “problematic portion” refers to a segment of the text data identified as containing at least one of an inappropriate expression or erroneous information, based on analysis by the generative artificial intelligence model and the processor.

The term “warning information” refers to data including one or more messages or indicators that inform the user, via the terminal, of the existence and nature of a problematic portion in the text data.

The term “summary text” refers to a condensed representation of long text that preserves essential information and key points while omitting less relevant details.

The term “emotional state” refers to an inferred condition of a user's affect, such as anger, dissatisfaction, satisfaction, or neutrality, derived from analysis of expressions and terms in the text data.

The term “processing priority” refers to a control parameter or ranking value assigned to text data that determines at least one of an order or urgency with which the server processes the text data.

The term “feedback information” refers to data that includes one or more messages, suggestions, or correction candidates generated for presentation to the user for improving or confirming the text data or for guiding the user in subsequent actions.

The term “guidance message” refers to a text message that advises or instructs the user regarding appropriate content, input format, next steps, or corrective actions.

The term “correction candidate” refers to an automatically generated suggestion for modifying a portion of the text data to remove inappropriate expressions, correct suspected errors, or improve clarity.

The term “real time” refers to a response characteristic in which the server processes text data and returns warning information, summary text, or feedback information to the terminal with latency sufficiently low that the user perceives the feedback during or immediately after input.

The term “emotion analysis technique” refers to a computational method that estimates an emotional state of a user from text data, including at least one of sentiment analysis, affective lexicon-based analysis, and machine-learned emotion classification.

The term “parameter of a prompt sentence” refers to a configurable attribute of the prompt sentence or associated model call, including but not limited to instruction content, level of detail, output format, or numerical settings that influence operation of the generative artificial intelligence model.

The term “processing order” refers to a sequence in which the server executes operations on multiple items of text data, such as validation, analysis, or routing, relative to each other.

The term “notification method” refers to a mode or pattern by which information is presented to or transmitted toward the user via the terminal, including at least one of display placement, visual emphasis, timing, and repetition.

The term “series of processing” refers to a coordinated set of operations applied to text data, including at least analysis, inappropriate expression detection, summary generation, priority setting, and feedback provision.

The term “corrected text data” refers to text data that has been modified by the user at the terminal in response to warning information or feedback information and subsequently retransmitted to the server.

In one embodiment, a server cooperates with one or more terminals operated by users to implement a text-processing system as defined in the claims. The server is implemented using a hardware platform such as a rack-mounted computer including at least one central processing unit (CPU), at least one graphics processing unit (GPU) or tensor processing unit (TPU), a main memory, a non-volatile storage device, and a network interface. The server executes an operating system such as a general-purpose server operating system, and executes application software implemented, for example, using a web framework such as a server-side scripting framework. The terminal is implemented using a mobile device, a tablet device, or a personal computer that executes a web browser or a native application.

The server stores a program in the non-volatile storage device. The server loads the program into the main memory and causes the processor to execute the program. The program includes modules for communication control, text normalization, linguistic analysis, emotion analysis, routing and prioritization, prompt sentence generation, interaction with a remote generative AI model via an API, response post-processing, and feedback control. The server uses a network interface and a protocol stack such as TCP/IP and HTTPS to exchange data packets with the terminal and with an external inference service that provides the generative AI model.

The terminal displays an information input interface to the user. The terminal uses a graphical user interface library, such as an HTML/JavaScript rendering engine for a web browser or a native UI toolkit, to present text fields and controls for entering payment-related information and free-form comments. The terminal locally validates simple format conditions, such as checking that a card number field contains only digit characters and that required fields are not empty. The terminal constructs a data structure, such as a JSON-like object, including user-entered text and meta-information such as timestamps and device identifiers. The terminal uses a networking library to encapsulate this data structure into an HTTP request and transmits the request over a secure connection to the server.

The server receives the HTTP request and reconstructs the text data into an internal representation in memory. The server uses a text normalization module to unify character encoding to a single internal encoding, to convert variant character forms to canonical forms, to delete unnecessary whitespace, and to standardize date and number formats. The server applies a sequence of deterministic transformations represented as functions on character arrays and token sequences. The server stores intermediate results in data structures such as token lists, n-gram tables, and feature vectors in memory. By normalizing and structuring the text in this way, the server reduces the dimensionality and variability of linguistic input, which improves the precision and speed of subsequent analysis and reduces the number of tokens that must be processed by the generative AI model, thereby lowering computational cost and network traffic.

The server uses a natural language processing engine to analyze the normalized text. The server segments the text into tokens using a tokenizer that performs rule-based splitting combined with a statistical model. The server optionally assigns part-of-speech tags and dependency relations to tokens using a trained sequence-labeling model, such as a bi-directional recurrent neural network or a transformer-based tagger. The server calculates feature vectors representing the frequency and co-occurrence of terms, sentiment scores, and syntactic patterns. The server identifies important terms by evaluating term weights, such as TF-IDF values or attention weights from an internal transformer encoder. The server thereby determines which segments of the text are relevant for routing, moderation, and summarization.

The server determines whether the input text should be treated as long text by comparing at least one of a character count and a token count of the text against a threshold. The server stores this determination in a field of an internal metadata structure associated with the text. This explicit classification allows the server to selectively invoke summarization processing only when necessary, which reduces unnecessary calls to the generative AI model and improves overall throughput.

The server selects a processing category, business division, or service type for the text based on the extracted important terms and on classification rules. In one embodiment, the server applies a multi-class classifier implemented as a feed-forward neural network or a gradient-boosted decision tree model that takes as input a vector of linguistic features (such as term frequencies, sentiment features, and detected entities) and outputs a distribution over service types. The server then selects the category with the highest probability exceeding a threshold. By using a learned classifier rather than static rules, the server can adapt to complex and evolving language patterns, thereby improving routing precision and reducing misclassification.

The server interacts with a generative AI model as a separate inference service. The generative AI model is implemented as a large-scale neural network, such as a transformer encoder-decoder architecture, trained on a large corpus of text data. The neural network includes an embedding layer, multiple self-attention layers, feed-forward layers, and output layers that generate probability distributions over tokens. The model is trained using a language modeling objective and optionally instruction-following fine-tuning, where a loss function such as cross-entropy is minimized over predicted token sequences using stochastic gradient descent or a variant thereof, such as Adam. During training, the model parameters (weights and biases) are updated iteratively using backpropagation. Data augmentation techniques, such as random masking of tokens, shuffling of paraphrased instructions, and injection of synthetic examples of inappropriate expressions and erroneous information, are used to improve robustness.

The server generates prompt sentences for the generative AI model in a structured manner. The server concatenates fixed instruction segments with dynamically extracted context from the user text. The server constructs different prompt templates for different purposes, such as inappropriate expression detection, error detection, summarization, and feedback generation. For example, the server may generate a first prompt sentence in the following form: “You are a content moderation and data validation assistant for an electronic payment service.

Analyze the following user input text.

1. Detect any inappropriate expressions or policy-violating content.

2. Detect any obviously malformed or suspicious payment-related information.

3. Return your findings in plain text, including specific examples and recommended warnings.

User input:

[USER_TEXT]”

Here, the server inserts the normalized user text into the placeholder [USER_TEXT]. The server then sends this prompt sentence as a textual payload to the generative AI model via an API request. The server uses a network client library to format the request according to a predetermined protocol, sets appropriate parameters such as model name, temperature, maximum output length, and top-k sampling settings, and transmits the request to the inference service. By controlling these parameters, the server can adjust the determinism and verbosity of the model output, which is important for consistent moderation and stable UI behavior.

The server also constructs a second prompt sentence for summarization when the text is classified as long text. An example of such a prompt sentence is:

“You are a summarization assistant for an electronic payment customer support system.

Summarize the following user-provided explanation into 3-5 sentences in English.

Preserve the main issues, reasons, and requests related to the payment or transaction.

Do not add any information that is not present in the original text.

User explanation:

[LONG_USER_TEXT]”

The server again substitutes the user explanation into the placeholder. The server transmits this prompt sentence together with the long text to the generative AI model and receives a summary. The server then stores the summary as part of the response to be sent to the terminal.

The server further constructs a third prompt sentence when feedback information is needed, such as:

“You are an assistant that helps users correct and improve their input for an electronic payment service.

Based on the analysis below, generate:

1. A guidance message explaining what the user should change.

2. One or more concrete correction candidates for problematic phrases.

Use clear and polite language.

Original user input:

[USER_TEXT]

Analysis result:

[ANALYSIS_RESULT]”

The server fills [ANALYSIS_RESULT] with a textual representation of internal analysis findings or with key excerpts from the generative AI model's earlier response. In this way, the server reuses structured information and reduces duplicated analysis. This chained prompting strategy leverages the generative AI model's capabilities while the server retains control over the flow and use of intermediate results.

The server analyzes the response data returned from the generative AI model. The server uses deterministic parsing rules to extract key elements such as identified inappropriate expressions, suspected erroneous information, recommended warnings, and summary sentences from the free-form output. In one embodiment, the server instructs the model to use explicit markers or list structures in plain text, enabling reliable recognition using pattern matching or regular expressions without requiring the model to output strict JSON. By implementing robust parsing logic, the server can transform natural language output into structured internal records that are stored as fields in memory. This enables the server to link problematic portions to specific character offsets or token indices in the original text.

The server uses an emotion analysis module to infer the emotional state of the user. The server computes sentiment and emotion features from the text, such as polarity scores, intensity scores, and occurrence of emotion-related terms. In one embodiment, the server uses a supervised classifier, such as a convolutional neural network or a transformer-based classifier, trained on annotated data that label text with categories such as anger, frustration, urgency, or satisfaction. The classifier outputs probabilities for each emotion category, and the server selects the dominant category and translates the probabilities into a processing priority score. The server then stores this priority score in association with the text, and uses it to influence routing decisions and scheduling of further processing.

The server uses the processing priority to reorder tasks in a request queue. For example, the server stores incoming text processing jobs in a priority queue data structure, where the key is a composite of arrival time and priority score. Jobs associated with higher urgency or with negative emotional states are dequeued and processed earlier. This scheduling mechanism reduces response latency for critical or sensitive interactions. The server thereby improves technical performance metrics such as average response time for high-priority cases, without increasing total computational resources.

The server modifies prompt sentences and model parameters according to the inferred emotional state. For users exhibiting high frustration or anger, the server may select a prompt variant that requests more detailed guidance and more empathetic phrasing in the feedback, while for neutral users, the server may request concise and direct feedback. The server changes temperature or maximum token parameters to control output variability and length. By dynamically adjusting these parameters, the server adapts model behavior in a way that is not achievable with static rule-based templates, leading to more appropriate and efficient responses for different categories of interactions.

The server generates warning information to be sent to the terminal. The server maps each problematic portion to a corresponding field in the user interface by referencing stored indices, such as field IDs and character ranges. The server creates a data structure containing warning messages, list of problematic phrases, and severity levels. The server then compresses or encodes this structure into a format suitable for network transmission, reducing payload size and thus network bandwidth consumption. The server sends the warnings and any generated summary or feedback to the terminal.

The terminal receives the response from the server and updates the display. The terminal highlights problematic fields, overlays warning messages adjacent to the relevant input controls, and displays the summary text in a designated area. The terminal does so using a rendering engine or UI toolkit, which changes the color, border, and icons of the input components. The terminal may also show a condensed banner or pop-up notification to attract the user's attention. In this way, the terminal visually ties server-generated technical analysis results to concrete interface modifications, thereby bridging internal server processing and user-visible effects.

The user reviews the warnings and summary on the terminal. The user edits the text accordingly, changing inappropriate phrases or correcting erroneous card numbers or addresses. The terminal captures the updated text and transmits it again to the server. The server applies the same processing as above to the corrected text, but can reuse certain cached features or routing categories when appropriate, further reducing computational cost. In this iterative manner, the server and terminal cooperate to converge to a text input that satisfies the defined constraints and is processed with improved accuracy.

The system yields technical effects that go beyond mere automation of human review. By integrating deterministic text normalization, learned classifiers, structured prompt sentence generation, and dynamic model parameter control, the server reduces redundant operations and network calls to the generative AI model, thereby improving throughput and lowering latency. The server organizes internal processing using specific data structures such as priority queues, feature vectors, and index mappings, which enable efficient scheduling, caching, and reuse of intermediate results. The server's use of emotion-aware prompt adjustment and priority scheduling improves the precision and relevance of model responses and reduces unnecessary recomputation. The generative AI model itself is trained using specific architectures, loss functions, and data augmentation strategies, which allow the model to capture complex patterns in real-world text that cannot be expressed easily as fixed rules.

In alternative embodiments, the server uses different natural language processing pipelines. For example, the server may use a smaller, locally hosted transformer model for initial screening and only call a larger remote generative AI model when the local model flags potentially problematic or ambiguous input. This two-stage architecture further reduces communication load and improves response speed for benign cases. In another embodiment, the server deploys multiple generative AI models specialized for different domains or languages and selects an appropriate model based on language detection or service type classification.

In another variation, the server couples the text processing pipeline with additional device control. For example, when the server determines that a critical error or highly inappropriate expression is present, the server sends a specific control signal to the terminal to disable a “Submit” button or to trigger a more prominent visual or audio alert. In this way, the system not only processes text but also exerts control over the behavior of the terminal, thereby providing a concrete technical control effect beyond information display.

In yet another embodiment, the server stores aggregated analysis statistics, such as distributions of detected inappropriate expressions or common error patterns, in a database optimized for analytical queries. The server periodically retrains local classifiers or updates routing rules based on these statistics. The server may adjust thresholds for long-text detection, modify prompt templates, and tune model parameters based on observed performance metrics such as false positive rates, false negative rates, and average processing time. This feedback loop contributes to continuous improvement of the underlying computer system without requiring manual rewriting of rule sets.

The system thus improves computer technology by defining and implementing a specific data flow, model interaction protocol, and control logic that collectively reduce computational overhead, improve analysis accuracy, minimize network usage, and enhance real-time responsiveness. The integration of natural language processing, generative AI model interaction via structured prompt sentences, emotion-based priority control, and UI-level device control represents a non-conventional and non-generic combination of components. The causal relationship between these components and the achieved technical effects can be summarized as follows: normalization and feature extraction reduce input variability and token counts; classifier-based routing restricts heavy processing to appropriate cases; structured prompt sentences and dynamic parameter control guide the generative AI model to generate targeted and parsable outputs; priority queues and caching mechanisms improve scheduling and reuse; and tight coupling with terminal control mechanisms ensures that detected issues immediately influence device behavior. As a result, the server operates more efficiently and reliably than conventional systems that rely only on static rule-based filters or separate, uncoordinated modules, and the system as a whole provides an improved technical solution for processing user-entered text in electronic services.

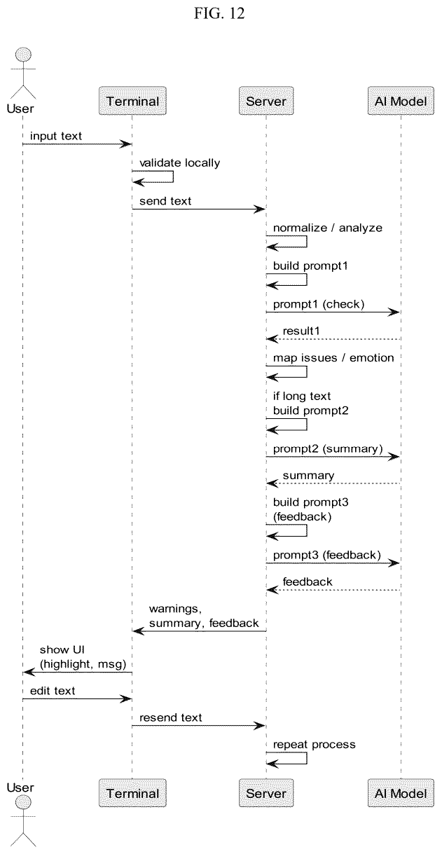

The following describes the processing flow using FIG. 12.

### Step 1:

The user operates the terminal to open an electronic payment screen or service input screen. The terminal displays multiple input fields, such as a card number field, an address field, and a free-text comment field, using a browser engine or native UI components.

The input of this step is user keystrokes and touch events; the terminal converts these events into character strings and stores them in local text buffers associated with each field.

The output of this step is a set of field values (for example, strings for card number, address, and comment) held in the terminal's memory.

### Step 2:

The terminal performs simple client-side validation on the field values.

The terminal checks, for example, that the card number field contains only digits and that required fields are not empty, using built-in string functions and regular expressions.

The input of this step is the set of field values created in Step 1.

The terminal processes these values by applying format-checking functions and generates a validation result, including flags and error messages for each field.

The output of this step is a validation result structure stored locally and a refined set of field values that either pass validation or are annotated as invalid.

### Step 3:

The terminal constructs a request payload to send to the server.

The terminal creates a data structure that includes the field values, simple validation results, timestamps, and a session identifier, and serializes it into a text-based format such as JSON.

The input of this step is the refined field values and local validation results from Step 2.

The terminal combines these elements into a structured payload and prepares HTTP headers, including authentication tokens if needed.

The output of this step is a complete HTTP request containing the serialized payload, ready for transmission over the network.

### Step 4:

The terminal transmits the HTTP request to the server over a secure channel.

The terminal uses a network library to open an HTTPS connection, send the request, and wait for the server's response.

The input of this step is the prepared HTTP request from Step 3.

The terminal encapsulates the request into network packets according to the TCP/IP stack and sends them to the server's network address.

The output of this step is the arrival of the request at the server and the initiation of a server-side processing session.

### Step 5:

The server receives the HTTP request through its network interface.

The server's protocol stack reconstructs the request payload from incoming packets, and an application layer framework routes the request to a handler module.

The input of this step is the raw network data containing the HTTP headers and body.

The server parses the HTTP structure, verifies authentication, and extracts the body text into an internal buffer in memory.

The output of this step is an internal representation of the user-submitted text data and metadata within the server application.

### Step 6:

The server parses and normalizes the text data.

The server uses a parsing library to interpret the serialized payload (for example, JSON) and extract individual fields such as card number, address, and comment into variables.

The input of this step is the payload text extracted in Step 5.

The server performs character code normalization, trims leading and trailing spaces, converts variant character forms (for example, full-width digits) to canonical forms, and standardizes date and number formats using deterministic string operations.

The output of this step is a set of normalized field values and a metadata object that records the normalized status, stored in memory.

Step 7: The server performs tokenization and linguistic analysis on the normalized text fields, especially the free-text comment.

The server applies a tokenizer that splits the comment into tokens (words or subwords) using language-specific rules and statistical models, and optionally assigns part-of-speech tags and dependency relations.

The input of this step is the normalized comment string and related text fields from Step 6.

The server converts the string into a sequence of tokens, computes features such as token frequency, sentiment indicators, and presence of specific patterns, and stores these features in vectors and lists.

The output of this step is a token sequence, associated linguistic annotations, and feature vectors representing the semantic and syntactic characteristics of the text.

### Step 8:

The server determines whether the text qualifies as long text.

The server counts characters and tokens in the comment field and compares the counts against a predefined threshold.

The input of this step is the token sequence and the original normalized comment from Step 7.

The server performs arithmetic operations on the lengths, sets a Boolean flag indicating long-text status, and records this flag in the metadata object.

The output of this step is an updated metadata object that specifies whether summarization processing should be invoked.

### Step 9:

The server performs routing and initial classification of the text to a processing category or service type.

The server uses the feature vectors from Step 7 as input to a classifier model (for example, a neural network or decision tree ensemble) that outputs probabilities for each service type.

The input of this step is the feature vectors, important terms, and any detected entities derived in Step 7.

The server multiplies feature values by model weights, applies activation functions, calculates a probability distribution, and selects the category with maximum probability above a threshold.

The output of this step is a selected processing category or service type stored in the metadata, which will be used to route subsequent processing and responses.

### Step 10:

The server constructs a first prompt sentence to request inappropriate expression detection and erroneous information detection from the generative AI model.

The server concatenates fixed instructional text with the normalized user comment and, optionally, with abbreviated representations of other fields such as partially masked card numbers or addresses.

The input of this step is the normalized text from Step 6, the analysis results from Step 7, and the selected category from Step 9.

The server formats these inputs into a coherent natural language instruction, inserting the user text into a placeholder such as “[USER_TEXT]” within the prompt template.

The output of this step is a fully formed first prompt sentence stored as a string in memory.

### Step 11:

The server sends the first prompt sentence to the generative AI model via an API request.

The server constructs an API call that includes the prompt sentence, model identifier, and inference parameters (such as temperature, maximum tokens, and top-k values), and transmits it over HTTPS to the inference service.

The input of this step is the first prompt sentence from Step 10 and configuration parameters stored in the server's settings.

The server serializes the request into a text-based message, sends it over the network, and waits for a response, thereby invoking the generative AI model's inference procedure on the remote hardware.

The output of this step is a pending network transaction and, eventually, a received model response containing analysis of inappropriate expressions and erroneous information.

### Step 12:

The server receives and interprets the response from the generative AI model for inappropriate expression and error detection.

The server parses the returned text, which may contain lists of problematic phrases and recommended warnings, using pattern-matching rules or delimiters specified in the prompt.

The input of this step is the raw response string from the generative AI model obtained via the API.

The server scans the string, extracts segments indicating inappropriate expressions, suspected erroneous information, and suggested messages, and stores these segments in structured fields such as arrays and maps.

The output of this step is a structured analysis object that associates specific findings with portions of the user text.

### Step 13:

The server maps the identified problematic portions to positions in the original text fields.

The server uses the normalized text and indices to find character ranges or token positions corresponding to the problematic phrases reported in the model response.

The input of this step is the structured analysis object from Step 12 and the normalized text from Step 6.

The server performs string-search operations, calculates byte or character offsets, and builds a mapping between problematic content and UI field identifiers.

The output of this step is a mapping structure that can be used to highlight fields and show targeted warnings on the terminal.

### Step 14:

The server determines the emotional state of the user from the analyzed text.

The server feeds the feature vectors, such as sentiment-related features and emotion-related terms, into an emotion classifier model that outputs probabilities for categories like anger, frustration, and neutrality.

The input of this step is the feature vectors and token sequence from Step 7.

The server performs matrix multiplications, applies activation functions, computes an output vector of emotion scores, and selects the dominant category along with a continuous priority score derived from the scores.

The output of this step is an emotion label and a processing priority value stored in the metadata associated with the user text.

### Step 15:

The server decides whether to generate a summary of the text based on the long-text flag and processing context.

The server checks the Boolean long-text flag from Step 8 and optionally considers service type and emotion to determine whether a summary would be beneficial.

The input of this step is the metadata object containing the long-text flag, the service type from Step 9, and the emotion label from Step 14.

The server evaluates logical conditions and, if the criteria are satisfied, sets a summarization-required flag.

The output of this step is an updated metadata object that indicates whether to invoke summarization.

### Step 16:

The server constructs a second prompt sentence to request summarization from the generative AI model when required.

The server uses a summarization template and inserts the long user explanation into a placeholder such as “[LONG_USER_TEXT]”, along with instructions about desired length and focus.

The input of this step is the long normalized text from Step 6 and the summarization-required flag from Step 15.

The server concatenates guidance text and the user explanation into a complete prompt string under conditions where summarization is required, or skips this construction if not required.

The output of this step is a second prompt sentence, ready to be sent to the generative AI model when summarization is needed.

### Step 17:

The server sends the second prompt sentence to the generative AI model and receives a summary.

The server constructs and transmits another API request containing the second prompt sentence and suitable inference parameters, then waits for the response.

The input of this step is the second prompt sentence from Step 16.

The server serializes the prompt into a request body, transmits it over HTTPS, and, upon receiving a response, reads the returned summary text from the response body.

The output of this step is a summary text string that captures the main points of the user's long explanation.

### Step 18:

The server constructs a third prompt sentence to generate feedback information such as guidance messages and correction candidates.

The server combines the original normalized text, the structured analysis object from Step 12, and optionally the emotion label from Step 14 into a textual context.

The input of this step is the normalized user text, the analysis results, and the emotion and priority information.

The server embeds these into a feedback prompt template, specifying that the generative AI model should produce clear guidance and concrete correction examples, and creates a third prompt sentence.

The output of this step is a third prompt sentence string that instructs the generative AI model to generate user-facing feedback.

### Step 19:

The server sends the third prompt sentence to the generative AI model and obtains feedback text.

The server constructs a final API request, including the third prompt and parameters tuned according to the emotion and priority (for example, more detailed feedback for highly frustrated users), and sends it to the inference service.

The input of this step is the third prompt sentence from Step 18 and the associated parameter settings.

The server receives the response, parses the generated feedback text, and extracts guidance messages and any suggested corrected phrases.

The output of this step is a feedback object containing user-readable guidance and correction candidates.

### Step 20:

The server assembles a response to the terminal that includes warnings, summary (if available), feedback, and control information.

The server packages the structured analysis results, mapping of problematic portions, summary text, feedback messages, emotion-based priority indications, and flags such as “canProceed” into a response data structure.

The input of this step is the mapping structure from Step 13, the summary from Step 17 (if any), the feedback object from Step 19, and the metadata including priority and service type.

The server serializes this data into a response payload, optimizes field sizes where possible, and prepares HTTP headers.

The output of this step is a complete HTTP response containing all necessary data for the terminal to update its user interface and control elements.

### Step 21:

The terminal receives and interprets the server's response.

The terminal's networking library reads the response, parses the payload, and converts it into an internal representation such as an object with fields for warnings, summary, and feedback.

The input of this step is the HTTP response payload from Step 20.

The terminal decodes the text, maps field identifiers to UI components, and stores warning messages and summary text in appropriate UI state variables.

The output of this step is an updated internal UI state that reflects server-side analysis and control instructions.

### Step 22:

The terminal updates the display and controls based on the received data.

The terminal highlights input fields associated with problematic portions, displays warning messages adjacent to those fields, and shows the summary in a designated area, using rendering routines.

The input of this step is the updated UI state from Step 21 and the mapping between problematic portions and field identifiers from the server.

The terminal modifies visual properties such as color, border style, and icons of the affected fields, and enables or disables action buttons (for example, the submit button) according to flags such as “canProceed”.

The output of this step is a visually updated user interface in which the user can see issues, suggested corrections, and a summarized view of their input.

### Step 23:

The user reviews the warnings, summary, and feedback on the terminal and edits the input accordingly.

The user reads the highlighted messages, consults the summary to confirm that the main points are correctly captured, and manually changes text fields to remove inappropriate expressions or correct erroneous information.

The input of this step is the updated interface showing server-derived warnings and guidance. The user interacts with the terminal through touch or keyboard input, and the terminal updates its local text buffers and validation results.

The output of this step is a new set of corrected field values in the terminal's memory, ready for resubmission.

### Step 24:

The terminal resubmits the corrected text data to the server, and the server repeats relevant processing steps.

The terminal constructs a new request payload, similar to Step 3, incorporating the corrected field values and possibly a reference to the previous transaction ID.

The input of this step is the corrected field values from Step 23.

The terminal sends the new payload to the server; the server again performs normalization, analysis, prompt generation, model interaction, and response assembly, but may reuse cached routing decisions or features to reduce computation.

The output of this step is a new server response that reflects the improved input; eventually, when no critical issues remain, the server sets a flag allowing the transaction or form submission to proceed.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In modern information processing environments, organizations frequently receive large volumes of free-form text information, such as inquiries, complaints, applications, survey responses, and feedback messages, via communication terminals. Conventional systems typically perform basic keyword filtering and rule-based routing to internal services or business units. However, such systems suffer from several technical limitations. First, conventional preprocessing pipelines for unstructured text are often fragmented and manually configured, resulting in inconsistent handling of missing values, noise characters, and heterogeneous formats. This leads to unstable data quality, increased error rates in downstream natural language processing, and degraded performance of classification and sentiment analysis modules executed by the processor.

Second, existing text classification architectures generally rely on a single type of model, such as a statistical learning model or a machine learning model, without systematically managing model confidence or integrating results with a generative AI model. When the model's confidence is low, the system either produces unreliable classification results or requires human intervention. This increases processing latency, reduces throughput, and prevents efficient utilization of computing resources.

Third, many current systems handle content moderation, summarization, sentiment analysis, and service routing as isolated functions. They do not provide a unified control flow in which the processor dynamically generates prompt sentences, coordinates calls to a generative AI model for multiple purposes (such as inappropriate expression detection, summary generation, and feedback generation), and integrates those outputs into a coherent data structure for further automated processing. As a result, communication overhead between components increases, and the system cannot fully exploit generative AI capabilities for automated decision support.

Fourth, conventional dashboards and reporting mechanisms are usually built on separate analytic layers that are loosely coupled to upstream classification and emotion analysis modules. Aggregation by theme, by emotion, and by time unit, as well as automatic detection of abnormal or rapidly increasing trends, are often implemented as ad-hoc scripts running outside of the core routing logic. This architecture increases data duplication, delays propagation of updated analysis results, and makes it difficult to present timely, context-aware visualizations to users.

Fifth, many systems do not provide a closed-loop mechanism for incorporating user corrections of classification results and emotion analysis results back into training data. Without such a feedback loop, the statistical learning models and machine learning models cannot be efficiently retrained to reflect evolving language patterns or domain-specific usage. This leads to stagnation in model accuracy and necessitates costly, manual retraining efforts. Accordingly, there is a need for a computer-implemented system that improves the way a processor preprocesses and analyzes text data, coordinates deterministic models and generative AI models via structured prompt sentences, generates consistent, machine-readable outputs for visualization, and continuously adapts its models based on user feedback. Such an improvement should reduce computational waste, lower error rates, and enhance the overall efficiency and reliability of computer-implemented information processing, rather than merely automating a human workflow.

The specific processing by the specific processing unit 290 of the data processing device 12 in Example 2 is realized by the following means.

The present invention provides a server comprising a processor configured to receive, from a communication terminal, structured information or unstructured information, store the received information in a data storage area, convert the received information into tabular data, and perform standardized preprocessing including missing-value completion, removal of unnecessary symbols, unification of character types, and integration of multiple items to generate analysis data; to perform language analysis processing on natural language text included in the analysis data, the language analysis processing including morphological analysis, part-of-speech tagging, and phrase segmentation, and to extract features for each item of the analysis data; to classify the information automatically into predetermined themes or classification items by using a statistical learning model or a machine learning model based on the extracted features, and to evaluate a confidence level of the automatic classification; to extract information having a confidence level below a threshold, generate an input sentence including a prompt sentence that instructs a generative AI model to perform theme classification or classification-result correction, transmit the input sentence to the generative AI model, and update the classification result based on a response from the generative AI model; to generate an input sentence including a prompt sentence for detecting presence or absence of inappropriate expressions or negative intent in expressions included in the information, provide the input sentence to the generative AI model, and determine inappropriate expressions based on a response from the generative AI model; to generate an input sentence including a prompt sentence for summary generation for an entire text of the information, transmit the input sentence to the generative AI model, and acquire summary information based on a response from the generative AI model; to analyze an emotional state of the information by using an emotion analysis technique, calculate a processing priority of the information according to emotional polarity or emotional intensity, and sort the classified information in order of priority based on the processing priority; to associate the information with a service type or a business type based on a classification result, an emotion analysis result, and the summary information or feedback information generated by the generative AI model, and convert an association result and statistical information into visualization data to generate an output data structure; to aggregate the classification result and the emotion analysis result by theme, by emotion, and by time unit, automatically detect a theme or a classification item having an abnormal trend or an increasing trend based on a result of the aggregation, and emphasize the theme or the classification item in the visualization data; and to receive user-initiated correction operations for the classification result and the emotion analysis result, store correction results as training records, and reflect the training records in retraining of the statistical learning model or the machine learning model so as to improve accuracy of subsequent classification processing or emotion analysis processing. This enables an integrated and technically improved information processing pipeline in which the processor consistently transforms heterogeneous text inputs into normalized analysis data, dynamically orchestrates conventional models and generative AI models through prompt sentences under programmatic control, automatically generates machine-readable outputs for visualization and routing, and adaptively refines its internal models based on user feedback, thereby enhancing computational efficiency, reliability, and scalability of computer-implemented text analysis and service assignment.

The term “processor” refers to a hardware computing element, such as a central processing unit or a graphics processing unit, configured to execute instructions of a program to perform the steps recited in the claims.

The term “communication terminal” refers to an electronic device operated by a user, such as a client computer, a portable terminal, or a communication-capable display device, that transmits information to and receives information from the server over a communication network.

The term “structured information” refers to information represented in a predefined data format, such as tabular data, record-oriented data, or field-based data, in which items are associated with explicit keys or columns.

The term “unstructured information” refers to information that is not constrained by a predefined schema, such as free-form text, message bodies, or narrative descriptions, in which semantic content is expressed primarily in natural language.

The term “data storage area” refers to a logical storage region provided by a storage device, such as a nonvolatile memory or a magnetic storage apparatus, configured to store received information, intermediate data, and analysis results.

The term “tabular data” refers to data arranged in a structure of rows and columns, such as a table or a matrix, where each row represents an instance and each column represents an attribute or field.

The term “preprocessing” refers to a sequence of operations applied to received information before higher-level analysis, including but not limited to missing-value completion, removal of unnecessary symbols, unification of character types, and integration of multiple items, so as to generate analysis data with a standardized format.

The term “missing-value completion” refers to an operation that fills or replaces absent or null data elements with substitute values, such as default values, inferred values, or placeholder identifiers, to prevent errors in subsequent processing.

The term “unnecessary symbols” refers to characters or character sequences that do not contribute meaningfully to semantic analysis, such as control characters, markup tags, redundant whitespace, or noise symbols introduced by encoding or entry errors.

The term “unification of character types” refers to an operation that normalizes variant character representations, such as converting between full-width and half-width characters or harmonizing letter cases, in order to reduce variability in text analysis.

The term “integration of multiple items” refers to an operation in which content from plural fields or attributes, such as a subject field and a body field, is combined into a single analysis field.

The term “analysis data” refers to data that has been transformed by preprocessing into a standardized format suitable for application of language analysis processing, classification processing, and emotion analysis.

The term “language analysis processing” refers to a sequence of natural language processing operations applied to text, including morphological analysis, part-of-speech tagging, and phrase segmentation, for the purpose of identifying linguistic units and their properties.

The term “morphological analysis” refers to an operation that segments text into minimal linguistic units, such as words or morphemes, and may assign base forms or stems to such units.

The term “part-of-speech tagging” refers to an operation that assigns grammatical category labels, such as noun, verb, or adjective, to tokens or words in text.

The term “phrase segmentation” refers to an operation that divides text into phrases or syntactic segments, such as noun phrases or verb phrases, based on linguistic criteria.

The term “features” refers to numerical values, categorical indicators, or symbolic descriptors extracted from text or analysis data, which are used as inputs to statistical learning models, machine learning models, or other analytical components.

The term “statistical learning model” refers to a model constructed by statistical techniques, such as regression, probabilistic modeling, or linear discriminant analysis, trained on sample data to estimate parameters for prediction or classification.

The term “machine learning model” refers to a computational model, such as a decision tree model, a neural network model, or a clustering model, that is trained using training data to perform tasks including classification, regression, or pattern recognition.

The term “theme” refers to a conceptual category or topic that represents a semantic grouping of information, such as a type of user concern, a service aspect, or a business subject.

The term “classification item” refers to a label or code assigned to information to indicate membership in a category, including but not limited to themes, service types, or business types.

The term “confidence level” refers to a numerical or symbolic indicator produced by a model that expresses a degree of certainty or reliability associated with a classification result.

The term “threshold” refers to a reference value used to compare with a confidence level or other metric, such that information exceeding or falling below the reference value is treated differently in subsequent processing.

The term “generative AI model” refers to a parameterized computational model, such as a sequence model or a transformer-based model, that generates text or structured outputs in response to input text and is trained on large data sets to capture patterns in natural language.

The term “prompt sentence” refers to a text string included in an input sentence that explicitly instructs a generative AI model to perform a designated operation, such as classification, inappropriate expression detection, or summary generation.

The term “input sentence” refers to a natural language text provided to a generative AI model, including one or more prompt sentences and content to be analyzed or processed.

The term “classification result” refers to data indicating one or more categories, themes, or classification items assigned to a unit of information by a statistical learning model, a machine learning model, or a generative AI model.

The term “inappropriate expression” refers to a text expression that violates predefined criteria, such as offensive language, discriminatory language, or noncompliant content, as determined by a detection process.

The term “negative intent” refers to an inferred intention that is critical, hostile, or otherwise negative in tone, as detected based on the semantic content of text.

The term “summary information” refers to text that concisely expresses the essential content of a longer text, generated by a summarization process.

The term “emotion analysis technique” refers to a computational technique that determines an emotional state, such as sentiment polarity or emotional intensity, based on features extracted from text.

The term “emotional polarity” refers to a classification of emotion into positive, negative, or neutral categories, or other coarse-grained sentiment categories.

The term “emotional intensity” refers to a measure indicating strength or magnitude of an emotional state associated with a unit of information.

The term “processing priority” refers to a ranking or level assigned to information that determines an order or urgency of processing operations performed by the system.

The term “service type” refers to a classification representing a type of service provided by an organization, such as support service, information service, or transaction service.

The term “business type” refers to a classification representing a type of business operation or business process, such as order processing, account management, or claims handling.

The term “association result” refers to data indicating a relationship between information and one or more service types or business types, derived from classification and analysis processes.

The term “statistical information” refers to aggregated numerical data, such as counts, ratios, averages, or distributions, computed from multiple classification results, emotion analysis results, or other analysis data.

The term “visualization data” refers to data structured so as to be convertible into graphical information or list information, including data for axes, labels, legends, and formatting of charts or tables.

The term “output data structure” refers to a structured representation that stores visualization data, association results, and statistical information, suitable for transmission to a client or further processing.

The term “graphical information” refers to visual representations, such as charts, graphs, or diagrams, that depict numerical or categorical relationships derived from analysis data.

The term “list information” refers to text-based representations, such as tables or lists, that enumerate classification items, counts, ratios, or representative examples.

The term “time-series trend” refers to a pattern of change in a metric, such as number of cases or sentiment ratio, observed across successive time units.

The term “representative opinions” refers to example text entries selected to exemplify typical content, issues, or sentiments within a category or cluster.

The term “aggregation processing” refers to a set of operations that combine multiple data records according to grouping keys, such as theme, emotion, or time unit, and compute aggregated metrics.

The term “abnormal trend” refers to a change pattern, such as a sudden increase or deviation from a baseline, that satisfies predetermined anomaly criteria in aggregated metrics.

The term “increasing trend” refers to a pattern in which a value, such as number of cases or negative sentiment ratio, increases over time beyond a predetermined reference.

The term “visualization data” (in the context of trend emphasis) refers to data that includes indicators for highlighting or distinguishing themes or classification items exhibiting an abnormal or increasing trend.

The term “correction operation” refers to an input by a user that modifies a classification result, an emotion analysis result, or another analysis output, to a value deemed correct by the user.

The term “training record” refers to data that stores an association between input features and a corrected label or output, such that the data can be used for training or retraining a statistical learning model or a machine learning model.

The term “retraining” refers to a process in which parameters of a statistical learning model or a machine learning model are updated by using training records, including correction results, to improve future performance.

The term “subsequent classification processing” refers to classification operations executed by a model after retraining has been performed using training records.

The term “subsequent emotion analysis processing” refers to emotion analysis operations executed by a model after retraining has been performed using training records.

In one embodiment, a server includes a hardware platform comprising at least one central processing unit, at least one main memory, a nonvolatile storage device, and a network interface controller. The server executes a program stored in the nonvolatile storage device and loaded into the main memory. The program is implemented, for example, using a general-purpose operating system, a web application framework such as a server-side application framework, and a set of libraries for data processing, natural language processing, and machine learning, such as a data frame library, a natural language processing library, and a machine learning library. The server is connected via a communication network to at least one terminal operated by a user. The terminal is, for example, a personal computer, a smartphone, or a tablet device executing a web browser or a dedicated client application.

The server receives structured or unstructured information from the terminal. The terminal uploads data in formats such as comma-separated value files or spreadsheet files through a graphical user interface. The server stores the uploaded files in a file system of the storage device and registers metadata of the files in a data management component, such as a relational data store. The server then converts the uploaded files into tabular data using a data frame library. For example, the server maps each row to a record and each column to a field in a table residing in volatile memory. The server applies standardized preprocessing operations to the tabular data. The server performs missing-value completion by replacing null entries with default strings or statistically estimated values. The server removes unnecessary symbols, such as markup tags, control characters, and repeated punctuation, using pattern matching functions. The server performs unification of character types, including conversion of character width and normalization of character case. The server further integrates multiple text fields, such as a subject field and a message body field, into a single analysis field, which is stored in a dedicated column that holds normalized text.

The server applies language analysis processing to the normalized text. The server invokes a natural language processing library to perform morphological analysis, part-of-speech tagging, and phrase segmentation. For example, the server applies a tokenization algorithm that segments a character sequence into tokens according to language-specific rules and statistical models. The server assigns part-of-speech tags to each token using a model trained on annotated corpora, implemented as a sequence model such as a conditional random field or a neural sequence tagger. The server identifies phrase boundaries and noun phrases using syntactic patterns learned from training data. The server extracts features from the processed text, including term frequency vectors, n-gram counts, word embeddings, and sequence-level statistics such as sentence length and vocabulary richness. These features are stored in in-memory feature matrices and associated with corresponding records in the tabular data.

The server utilizes a statistical learning model or a machine learning model to classify each record into a theme or classification item. In one embodiment, the server uses a linear classifier, such as logistic regression, trained over a high-dimensional sparse feature space derived from term frequency-inverse document frequency vectors. In another embodiment, the server uses a multilayer neural network comprising an input layer that receives embedding vectors, one or more hidden layers with nonlinear activation functions, and an output layer that outputs probability scores for each category via a softmax function. The server loads trained model parameters from the storage device into memory and applies matrix multiplications and activation functions to compute category probabilities for each input record. The server records the category with the highest probability as a classification result and stores associated probability scores as confidence levels.

The server evaluates the confidence level for each classification result. When the confidence level for a record falls below a threshold, the server selects that record for further refinement using a generative AI model. The server constructs an input sentence that includes a prompt sentence and one or more text items to be classified. The prompt sentence is formulated in natural language to instruct the generative AI model to perform theme classification or classification-result correction. An example of such a prompt sentence is: “Classify each of the following customer feedback messages into one of these categories: ‘delivery speed’, ‘product quality’, ‘customer service’, ‘website usability’, or ‘other’. For each message, output the category and a short explanation of why you chose that category. Feedback messages: 1: ‘The package arrived two days earlier than expected, very happy.’ 2: ‘The item stopped working after a week and feels very cheaply made.’ 3: ‘The support team was polite, but it took too long to get a response.’”

The server transmits the input sentence to an external or internal generative AI model via the network interface. The generative AI model is implemented, for example, as a transformer-based neural network with multiple attention layers, feedforward layers, and layer normalization. The model is pre-trained on large-scale text corpora and optionally fine-tuned on domain-specific data. The server receives a text response from the generative AI model and parses the response to extract corrected categories and explanatory text. The server updates the classification result in the tabular data by replacing or supplementing low-confidence categories with the categories obtained from the generative AI model.

The server also performs detection of inappropriate expressions or negative intent in the text.

The server constructs a second input sentence including a prompt sentence that instructs the generative AI model to identify offensive language, prohibited terms, or harmful intent. An example of such a prompt sentence is:

“Check the following user messages and indicate for each message whether it contains inappropriate expressions such as insults, discriminatory statements, or threats. For each message, output ‘appropriate’ or ‘inappropriate’ and briefly describe the reason. Messages: 1: ‘You people are useless and should be fired.’ 2: ‘The delivery was slow, but the staff was kind.’”

The server sends the input sentence to the generative AI model and obtains a response specifying appropriateness judgments. The server stores flags indicating presence or absence of inappropriate expressions in dedicated fields of the tabular data. The server may combine this result with rule-based filters implemented as pattern-matching expressions to further reduce false negatives or false positives.

The server further generates summary information for long texts. The server composes an input sentence that includes a prompt sentence instructing the generative AI model to output a concise summary. For example, the server generates a prompt sentence such as:

“Summarize the following customer feedback in no more than three sentences, focusing on the main problems and positive points. Feedback: ‘ . . . ’”

The server receives a summarization output as text from the generative AI model and writes the summary into a summary field for each record. The server stores both the original text and the summary in the storage device, allowing subsequent components to use shorter representations when appropriate, thereby reducing memory usage and network transmission size for downstream operations.

The server performs emotion analysis on each text instance. The server may apply a machine learning model trained to output an emotional polarity label, such as positive, neutral, or negative, and an emotional intensity score. In one embodiment, the server uses a neural network classifier that receives word or sentence embeddings as inputs and outputs sentiment logits. The server applies an activation function and selects the label corresponding to the maximum logit. The server calculates a processing priority score by mapping emotional polarity and intensity to a numerical scale, where highly negative and high-intensity messages receive higher priority scores. The server stores the processing priority in the tabular data and uses this score to determine ordering of further processing and presentation.

The server associates each record with one or more service types or business types. The server uses a mapping rule that references the classification result, the emotion analysis result, and the summary information. For example, if the classification result indicates “delivery speed” and the sentiment is highly negative, the server may associate the record with a logistics service type and an escalation-level handling type. The server stores association results as structured fields. The server uses these fields to construct visualization data by aggregating counts, ratios, and time-series statistics. The server generates an output data structure containing numerical arrays for chart axes, category labels, sentiment labels, and indicators for highlighting abnormal or increasing trends. The server stores the output data structure in memory or in a database for subsequent retrieval.

The server aggregates classification and emotion analysis results across multiple records. The server groups records by theme, emotion, and time unit and computes aggregate metrics such as the number of cases per theme per day, the ratio of negative sentiment per service type, and rolling averages of complaint volume. The server applies statistical detection algorithms, such as threshold-based anomaly detection or z-score detection, to identify themes with abnormal trends or rapidly increasing negative sentiment. The server marks such themes with emphasis flags and includes these flags in the visualization data. When the server later generates graphical information, such as bar charts or line graphs, the server uses the emphasis flags to draw attention to problematic categories by changing colors or annotations, thereby enabling faster recognition of emerging issues.

The server generates graphical information and list information based on the output data structure. The server uses a plotting library to convert numerical arrays into rendered images, such as bar charts showing counts per category, stacked bar charts showing emotion ratios, and line charts showing time-series trends. The server generates list information in the form of tabular layouts, including columns for category, number of cases, sentiment ratios, and representative opinions. Representative opinions are selected by the server using rules such as highest emotional intensity or typicality within a cluster. The server stores the generated graphical files and list structures on the storage device and sends references or embedded representations of these visualizations to the terminal via a network protocol.

The terminal receives the graphical information and list information from the server and renders them on a display device. The terminal allows the user to apply filters, such as time range and category filters, through user interface controls. The terminal sends filter conditions back to the server. The server recalculates aggregates and regenerates visualizations according to the filter conditions. By reducing the size of transmitted data to high-level metrics and images, rather than raw text, the server decreases network bandwidth usage and speeds up display updates.

The server accepts correction operations from the user. For example, the terminal provides an interface where the user can change a classification label assigned to a specific record or adjust an emotion label. When the user performs such an operation, the terminal sends a correction request to the server. The server records the corrected label along with the original features and stores this association as a training record. The server maintains a training data repository of such correction-based examples. At scheduled intervals or when a sufficient number of training records is accumulated, the server retrains its statistical learning models or machine learning models. In the retraining process, the server uses an optimization algorithm, such as stochastic gradient descent or a variant thereof, to minimize an error function, such as cross-entropy loss between predicted labels and corrected labels. The server updates model parameters, such as weights in the neural network or coefficients in the linear classifier, and saves the updated model in the storage device. Subsequent classification and emotion analysis processing uses the retrained models, which improves accuracy and reduces future misclassifications.

By integrating the preprocessing, feature extraction, model-based classification, generative AI refinement, emotion analysis, and visualization in a unified data flow, the server improves computer operation compared to conventional ad hoc scripts or manually chained tools. The server maintains data in consistent tabular and feature matrix structures, thereby reducing redundant parsing and transformation operations. This structural uniformity allows the server to reuse intermediate representations across multiple analytical modules, which reduces memory duplication and CPU cycles. The dynamic use of confidence thresholds to decide when to invoke the generative AI model enables the server to reserve high-compute generative processing for only the most ambiguous cases. As a result, average processing time and computational cost per record are reduced, while maintaining or increasing classification accuracy.

Furthermore, the server's explicit generation and management of prompt sentences, and the storage of model responses in structured fields, constitute a technical improvement over naive text-level use of generative models. Rather than relying on opaque end-to-end text generation, the server constrains and structures the interaction with the generative AI model through well-defined input sentences and expected output formats. This structured interaction allows the server to programmatically validate, parse, and integrate the AI outputs into the existing data structures. In one embodiment, the server uses specialized tokens in the prompt sentence to delimit sections and thereby improve parsing reliability. This improves robustness of the system and reduces error propagation, which is a technical effect on computer operation.

In additional embodiments, the server may deploy different types of generative AI models, such as models specialized for classification, summarization, or toxicity detection, and select an appropriate model based on the type of processing requested. The server can also cache AI responses for frequently occurring texts or patterns, thereby reducing repeated calls and lowering communication load with external AI services. The server may compress tabular data and feature matrices using columnar compression or sparse encoding schemes to reduce storage footprint and accelerate I/O operations.

In another embodiment, the server runs on a distributed computing environment where multiple processing nodes share workloads across a cluster. The server distributes preprocessing and feature extraction tasks across nodes using batch scheduling. Aggregation and visualization data structures are computed centrally from partial aggregates computed on each node. This parallelization further improves throughput and allows processing of large-scale text datasets that would be impractical with purely manual or sequential methods. By designing the system as a set of cooperating software modules executing on specific hardware resources, and by specifying concrete data structures, model architectures, optimization procedures, and structured interactions with a generative AI model using prompt sentences, the invention improves the manner in which the computer processes, analyzes, and presents large volumes of natural language information. The server achieves higher classification accuracy through confidence-based generative AI refinement, reduces computation and communication overhead by selective invocation and caching, and enhances data management by maintaining consistent tabular and feature representations. These technical effects go beyond mere automation of human judgment and constitute a demonstrable improvement in computer technology for text analysis and service assignment.

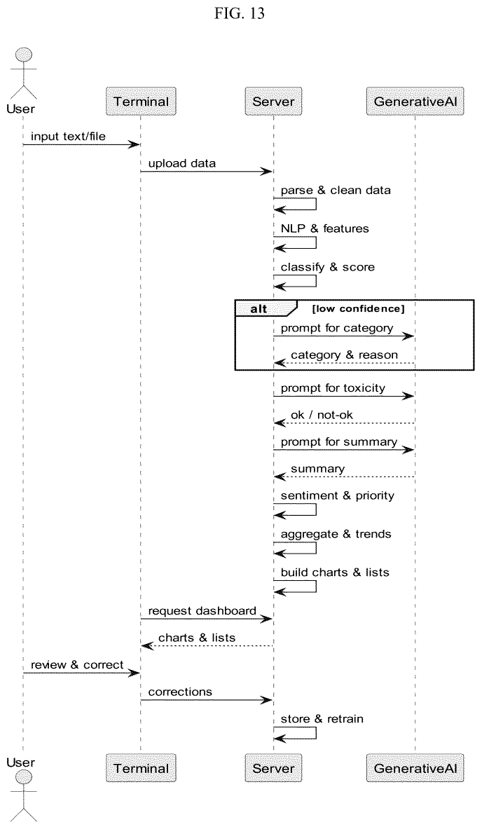

The following describes the processing flow using FIG. 13.

### Step 1:

Server receives information from the terminal.

Server accepts an upload request from the terminal that contains input files (for example, CSV or spreadsheet files) and optional parameters (for example, project identifier, language setting, and encoding). The input is binary file data and HTTP parameters sent over a network connection. Server writes the file data to a storage device and registers metadata such as file name, upload time, and user identifier in a data management table. The output of this step is a stored file path and a metadata record associated with a newly issued job identifier.

### Step 2:

Server converts uploaded files into tabular data.

Server reads the stored files from the storage device and interprets them according to their format (for example, comma-separated values or spreadsheet format). The input is the stored file path and associated metadata. Server invokes a data frame library to parse rows and columns and constructs an in-memory table where each row corresponds to one user response or application and each column corresponds to a field such as timestamp, user identifier, and free-text content. Server checks for parsing errors and logs any malformed records. The output of this step is a tabular data structure, such as a data frame, containing all successfully parsed records.

### Step 3:

Server performs standardized preprocessing on the tabular data.

Server receives the tabular data as input and applies a sequence of transformations to generate normalized analysis data. Server performs missing-value completion by scanning each column for null entries and replacing them with default strings, numerical defaults, or inferred values. Server removes unnecessary symbols from text fields using pattern matching to delete markup tags, control characters, and redundant whitespace. Server unifies character types by converting characters to a standardized case and width and normalizing encoding forms. Server integrates multiple text fields (for example, subject and body) into a single analysis text field by concatenating them with delimiters. The output is an updated tabular data structure that includes a normalized text column and cleaned values in all relevant fields.

### Step 4:

Server performs language analysis processing on normalized text.

Server takes the normalized tabular data as input and applies a natural language processing library to the analysis text column. Server executes tokenization to split text into tokens, attaches part-of-speech tags to each token, and segments text into phrases based on learned syntactic patterns. Server computes linguistic features such as token lists, lemma lists, and phrase boundaries and stores them in additional columns or auxiliary structures linked to each row. Server also calculates numerical features such as token counts, average token length, and specific keyword frequencies. The output of this step is a feature-enriched tabular data structure and an associated feature matrix suitable for model input.

### Step 5:

Server classifies information using a statistical learning model or a machine learning model. Server uses the feature matrix and the corresponding records as input. Server applies a feature transformation, such as term frequency-inverse document frequency, to convert token counts into weighted feature vectors. Server loads pre-trained model parameters from storage, such as weights of a linear classifier or parameters of a neural network. Server performs matrix multiplications and applies activation functions to compute probability scores for each possible theme or classification item for every record. Server selects the category with the highest probability as the primary label and records the associated probability as a confidence level. The output is the original tabular data augmented with fields representing the classification result and the confidence level for each record.

### Step 6:

Server identifies low-confidence classifications and prepares generative AI refinement. Server scans the classification results and compares each confidence level with a predefined threshold. The input is the augmented tabular data containing confidence levels. Server selects records with confidence levels below the threshold and extracts their normalized text. Server groups selected texts into batches and, for each batch, constructs an input sentence that includes a prompt sentence and the list of texts. Server formats the prompt sentence in natural language to instruct a generative AI model to classify or correct categories. An example of such a prompt sentence is:

“Classify each of the following customer feedback messages into one of these categories: ‘delivery speed’, ‘product quality’, ‘customer service’, ‘website usability’, or ‘other’. For each message, output the category and a short explanation of why you chose that category.

Feedback messages: . . . ”

The output of this step is a set of input sentences ready to be transmitted to the generative AI model and a list of corresponding record identifiers for mapping responses.

### Step 7:

Server refines classifications using a generative AI model.

Server sends each input sentence created in Step 6 to a generative AI model via a network interface. The input is the text of the input sentence, including the prompt sentence and batched feedback texts. Server receives a text response from the generative AI model that includes suggested categories and explanations. Server parses the response, extracts the category labels and reasons for each feedback message, and aligns them with the corresponding records using the stored identifiers. Server updates the classification result fields for low-confidence records, either replacing the original label or storing the generative AI label in a dedicated field. The output is a revised tabular data structure in which low-confidence classifications are refined with results informed by the generative AI model.

### Step 8:

Server detects inappropriate expressions and negative intent.

Server takes the normalized text and identification of target records as input. Server constructs an input sentence that includes a prompt sentence instructing the generative AI model to judge appropriateness. An example of such a prompt sentence is:

“Check the following user messages and indicate for each message whether it contains inappropriate expressions such as insults, discriminatory statements, or threats. For each message, output ‘appropriate’ or ‘inappropriate’ and briefly describe the reason. Messages: . . . ”

Server sends the input sentence to the generative AI model and receives a response indicating appropriateness assessments and reasons. Server parses the response and, for each record, sets a flag representing presence or absence of inappropriate expressions and stores an optional explanation. The output is the original tabular data augmented with appropriateness flags and explanatory text fields.

### Step 9:

Server generates summary information for long texts.

Server selects records containing long analysis text and uses them as input. Server constructs an input sentence containing a prompt sentence, for example:

“Summarize the following customer feedback in no more than three sentences, focusing on the main problems and positive points. Feedback: . . . ”

Server transmits the input sentence to the generative AI model and receives a summary result as natural language text. Server writes the summary text into a summary field associated with each original record. Server may also store summary length and quality indicators. The output of this step is an augmented tabular data structure containing summaries for each long-form text entry.

### Step 10:

Server analyzes emotion and computes processing priority.

Server uses the normalized text and extracted features as input. Server applies a sentiment or emotion analysis model, which receives embeddings or feature vectors for each record and outputs an emotional polarity label and an emotional intensity score. Server maps the combination of polarity and intensity to a numerical processing priority score according to a predefined mapping rule, for example assigning higher scores to highly negative, high-intensity messages. Server writes the emotional labels and priority scores into dedicated fields in the tabular data. The output is the tabular data extended with emotion labels and processing priority values for each record.

### Step 11:

Server associates records with service types or business types.

Server takes classification results, refined categories, emotion analysis outputs, summaries, and appropriateness flags as input. Server applies rule sets or mapping tables that relate themes and emotions to specific service types or business processes. For example, server may map records with a “delivery speed” theme and high negative sentiment to a logistics service type requiring escalation. Server generates fields such as service type, business type, and escalation level and assigns values based on the mapping logic. The output is the tabular data further enriched with association results that indicate which internal service or business area each record should be routed to.

### Step 12:

Server aggregates results and detects abnormal or increasing trends.

Server uses the enriched tabular data as input and groups records by theme, service type, emotion, and time unit, such as day or week. Server performs aggregation operations to compute metrics including total counts, positive and negative sentiment ratios, and moving averages of key indicators. Server applies anomaly detection rules, for example checking whether the negative sentiment ratio for a theme exceeds a threshold or whether the number of complaints for a service type increases beyond a predefined rate. Server marks themes or categories that satisfy anomaly criteria with emphasis flags. The output of this step is a set of aggregated records and trend indicators, organized in a structure suitable for visualization.

### Step 13:

Server constructs an output data structure for visualization.

Server takes aggregated metrics, emphasis flags, and association results as input. Server converts these inputs into visualization data describing chart axes, category labels, color assignments, and highlight markers. Server organizes numerical values and labels into arrays or tables that represent bar heights, segment proportions, and time-series points. Server composes an output data structure that includes both graphical data definitions and list information, such as tables listing categories, counts, sentiment ratios, and representative opinions selected from records with high emotional intensity or typical text patterns. The output is a structured visualization object stored in memory or a database.

### Step 14:

Server generates graphical information and list information for the terminal.

Server receives the visualization object from Step 13 as input. Server calls a visualization library to create graphical representations such as bar charts, stacked emotion charts, and line graphs of time-series data. Server renders these charts into image formats or encodes them for interactive display. Server also formats list information into table layouts, arranging columns for category, count, sentiment distribution, flags for abnormal trends, and representative text snippets. Server writes the generated images and list structures to the storage device and prepares response messages containing either references to these resources or embedded data. The output is a set of display-ready visual artifacts and associated metadata.

### Step 15:

Terminal requests and displays analysis results.

Terminal sends a request to the server specifying a job identifier and optional filter conditions, such as category range or time period. The input to the terminal is the response from the server containing graphical information, list information, and metadata. Terminal interprets the received data and renders charts and tables on the display. Terminal provides user interface elements that allow the user to change filters, select categories, or drill down into detailed records. When the user adjusts filters, the terminal sends updated filter conditions to the server. The output of this step is a dynamically updated visualization on the user's display that reflects the processed analysis data.

### Step 16:

User reviews results and performs correction operations.

User observes the charts, tables, and summaries on the terminal and identifies any misclassified records or incorrect emotion labels. User interacts with the terminal to correct labels, for example by selecting a record and choosing a new theme category or sentiment label from a list. Terminal sends the correction information, including record identifier and corrected label, to the server as an update request. The input to the user is the visualized analysis; the output is a set of correction commands transmitted to the server.

### Step 17:

Server stores correction records and updates training data.

Server receives correction commands from the terminal as input. Server locates the corresponding records in the tabular data and writes corrected labels into correction fields while preserving the original labels for comparison. Server constructs training records that pair the original feature vectors with the corrected labels and appends them to a training data repository. Server records timestamps and source identifiers for traceability. The output is an updated training data set containing user-validated examples linked to specific model outputs.

### Step 18:

Server retrains models using accumulated training records.

Server periodically or conditionally loads the training data repository as input. Server initializes parameters of the statistical learning models or machine learning models and applies a training algorithm, such as gradient-based optimization, to minimize a loss function measuring differences between model predictions and corrected labels. Server updates model parameters iteratively until a stopping criterion is met, such as convergence of loss or completion of a fixed number of epochs. Server then replaces or augments previously deployed models with the retrained models by storing updated parameters in the storage device and reloading them into memory. The output of this step is a refreshed set of models with improved classification and emotion analysis performance, which are used in subsequent executions of earlier steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that handle user-submitted free-text data, such as inquiries, reports, applications, and transaction requests, typically rely on a combination of fixed keyword rules and manually designed workflows. Such systems suffer from several technical limitations.

First, conventional systems perform text parsing and routing using static rule sets that do not adapt well to diverse natural language expressions. As a result, the processor may require repeated passes over the same data or manual intervention to correctly identify topics and assign the data to appropriate processing units. This leads to inefficient utilization of computing resources, increased latency in routing and decision-making, and reduced scalability when handling large volumes of text data.

Second, traditional systems often treat tasks such as inappropriate expression detection, summarization of long text, and sentiment or emotion analysis as disjoint modules, each with its own processing pipeline. This fragmented architecture causes redundant parsing and transformation of the same input text, increasing memory usage and processor time, and complicating state management across modules. It also makes it difficult to consistently combine these individual analysis results into a unified decision for prioritization, approval, or feedback generation, thereby reducing the technical effectiveness of automated processing. Third, many existing systems do not exploit modern generative AI models in a structured, prompt-driven manner. When generative models are used, they are often invoked with ad hoc prompts and without standardized integration with upstream natural language processing and downstream workflow logic. This results in non-deterministic behavior, difficult-to-reproduce outputs, and inconsistent quality of summarization, classification, and recommendation. The lack of a systematic prompt sentence design that encodes analysis results and decision criteria reduces the reliability and repeatability of AI-assisted decisions. Fourth, conventional architectures rarely integrate user emotion estimation as a first-class computational signal within the processing pipeline. When sentiment or emotion is considered, it is typically analyzed only for reporting or visualization, not as an input to routing priority, urgency scoring, or approval decisions. This omission prevents the processor from dynamically adjusting processing flows (for example, holding or accelerating certain transactions) based on the detected emotional state, and therefore limits the system's ability to allocate resources and schedule tasks in a technically optimized manner.

Fifth, existing systems generally lack an integrated mechanism to aggregate topic information, summary text, and emotion information across many items and feed those aggregated statistics back into a generative AI model to produce machine-generated analytical reports and decision support outputs. As a consequence, the processor cannot efficiently offload higher-level analysis and report drafting to the AI model, and instead must rely on separate analytics tooling and manual authoring, which increases processing complexity and delays.

Accordingly, there is a need for an improved information processing system and server-side architecture in which a processor coordinates conventional natural language processing, emotion analysis, and generative AI model invocation through well-structured prompt sentences, such that (i) text routing, moderation, summarization, prioritization, approval decision-making, visualization, and feedback generation are executed as a coherent pipeline, (ii) redundant computations are reduced, and (iii) the quality, consistency, and traceability of AI-assisted outputs are improved. The technical problem addressed by the present invention is therefore to provide a processor-controlled system that uses integrated NLP and generative AI prompts, together with emotion-aware prioritization and approval logic, to improve computational efficiency, response latency, and decision reliability in the automated processing of user-submitted text data.

The specific processing by the specific processing unit 290 of the data processing device 12 in Application Example 2 is realized by the following means.

The present invention provides a server comprising a processor configured to receive text data and metadata from user terminals, perform a unified natural language processing sequence including morphological analysis, part-of-speech tagging, and syntactic parsing to extract important expressions and topic information, and generate structured intermediate analysis results that are reused across multiple downstream tasks; to automatically sort the text data into organizational units or processing flows based on the extracted topic information and predetermined classification rules; to generate standardized prompt sentences that embed the text data and specific task instructions for inappropriate-expression detection, summarization, trend analysis, and decision support, and to input the prompt sentences into a generative AI model in order to obtain machine-generated outputs such as lists of inappropriate expressions, summary texts, topic-wise trend reports, and proposed approval or rejection decisions; to input the text data and feature information including user input behavior or environment information into an emotion analysis model to obtain emotion labels and emotion intensities, and to determine priority or urgency of each piece of text data based on the obtained emotion labels and emotion intensities; to aggregate topic information, summary texts, and emotion information for a plurality of records and compute occurrence frequencies, evaluation tendencies, and emotion distributions per topic, and to generate prompt sentences including such aggregated analysis results as structured input to the generative AI model for creation of higher-level analytical reports and feedback messages; to classify the text data into predetermined service types or processing flows and to select and execute, according to the generative AI model outputs and the emotion analysis results, an approval process, a hold process, or a reconfirmation process for electronic transaction requests or applications, while generating visualization data in a graph or chart format for presentation to user terminals. This enables an integrated, computer-implemented processing pipeline in which the processor minimizes redundant analysis operations, systematically leverages generative AI model capabilities through well-defined prompt sentences, dynamically adjusts routing, priority, and approval states based on both textual content and user emotion, and thereby improves computational efficiency, response time, and consistency of automated content moderation, summarization, decision-making, and feedback generation in comparison with conventional rule-based or modular systems.

The term “system” refers to an information processing arrangement including at least one server device and one or more user terminals that are interconnected via a communication network and that cooperate to process user-submitted data according to predefined procedures.

The term “server” refers to a computing apparatus, typically including one or more processors, memory, and communication interfaces, that executes programs to receive, analyze, classify, and respond to data transmitted from user terminals.

The term “processor” refers to a hardware processing unit, such as a central processing unit or a processing core, that executes instructions stored in a memory to perform data processing operations specified in the present disclosure.

The term “user terminal” refers to an electronic device operated by a user, such as a personal computer, smartphone, tablet, or other client device, that transmits text data and metadata to the server and receives responses or visualizations from the server.

The term “text data” refers to information expressed in natural language characters, including words, sentences, and paragraphs, which is input by a user or generated by a machine and processed by the server.

The term “metadata” refers to auxiliary data associated with the text data, including but not limited to user identifiers, timestamps, form types, communication channels, and other contextual or descriptive attributes.

The term “natural language processing” refers to computational techniques for analyzing, understanding, and transforming human language text, including operations such as morphological analysis, part-of-speech tagging, syntactic parsing, and semantic extraction.

The term “morphological analysis” refers to processing that segments text into minimal linguistic units, such as words or morphemes, and identifies their base forms or inflected forms.

The term “part-of-speech tagging” refers to processing that assigns grammatical categories, such as noun, verb, adjective, or adverb, to each token in the text.

The term “syntactic parsing” refers to processing that analyzes the grammatical structure of a sentence, including phrase boundaries and dependency relations between words.

The term “important expressions” refers to words, phrases, or other linguistic units extracted from the text data that are determined to have high relevance for classification, routing, or decision-making according to predetermined rules or models.

The term “topic information” refers to data indicating one or more subject matters or themes inferred from the text data, such as service category, product aspect, or issue type, which are used for classification and aggregation.

The term “classification rules” refers to predefined conditions, mappings, or algorithms that specify how text data should be assigned to organizational units, service types, or processing flows based on extracted features such as important expressions or topic information.

The term “organizational unit” refers to a logical or physical division within an entity, such as a department, team, or functional group, that is responsible for handling a particular class of information.

The term “processing flow” refers to a sequence of processing steps or a workflow path along which the server handles the text data, including validation, analysis, decision, and feedback steps.

The term “prompt sentence” refers to a structured natural language instruction, optionally including embedded data such as text content or analysis results, that is provided as input to a generative AI model to specify a target processing task and expected output format.

The term “generative AI model” refers to a trained computational model based on machine learning, such as a neural network language model, that generates or transforms text in response to a prompt sentence, and is capable of tasks including classification, summarization, and recommendation.

The term “inappropriate expression” refers to a word, phrase, or combination of terms within the text data that is determined to be offensive, prohibited, or otherwise undesirable according to a moderation policy or criteria.

The term “summary text” refers to a reduced-length representation of the original text data, generated so as to preserve essential information while omitting less important details.

The term “summarization conditions” refers to parameters or instructions included in a prompt sentence that specify constraints or goals for generating the summary text, such as length, focus topics, or level of detail.

The term “emotion analysis model” refers to a computational model that receives text data and/or user-related features as input and produces an estimate of a user's emotional state, such as an emotion label and an emotion intensity score.

The term “user input behavior information” refers to data describing how a user interacts with an input interface, including but not limited to typing speed, correction frequency, and interaction patterns.

The term “environment information” refers to contextual data related to the user or device environment, such as device type, network conditions, or, when permitted, sensor information such as audio or image-derived features.

The term “emotion label” refers to a categorical value representing an estimated emotional state of a user, such as calm, stressed, angry, or sad.

The term “emotion intensity” refers to a quantitative value indicating the strength or degree of the estimated emotional state associated with an emotion label.

The term “priority” refers to a relative processing order or importance level assigned to a piece of text data, which influences scheduling or resource allocation in the server.

The term “urgency” refers to a measure indicating how quickly a piece of text data should be processed or responded to, often based on content and emotional state.

The term “analysis unit” refers to a functional component implemented by the processor that aggregates and computes statistics, such as occurrence frequencies and distributions, from multiple pieces of text data and associated attributes.

The term “occurrence frequency” refers to a count or rate indicating how often a particular topic, expression, or label appears across a set of text data.

The term “evaluation tendency” refers to a statistical pattern indicating the distribution of evaluations or sentiments, such as positive, negative, or neutral, associated with a particular topic.

The term “emotion distribution” refers to a statistical representation of how different emotion labels and intensities are distributed across text data associated with a given topic or category.

The term “analysis results” refers to data generated by the analysis unit, including but not limited to topic frequencies, evaluation tendencies, emotion distributions, and derived metrics used for further processing and reporting.

The term “trend report” refers to a text or data representation describing changes or patterns over time or across categories, such as increasing complaints about a topic or shifts in user emotion.

The term “approval criteria information” refers to predefined conditions, thresholds, and rules used to determine whether a transaction or application should be approved, rejected, or held.

The term “determination information” refers to data output from the generative AI model or internal logic that indicates a recommended decision such as approval, rejection, or hold, possibly accompanied by explanatory text.

The term “approval state” refers to a status value assigned to a transaction or application, indicating that it is approved, rejected, or held pending further review.

The term “approval process” refers to a sequence of server-side operations performed when an approval state indicates that a transaction or application is accepted, such as committing records and initiating subsequent actions.

The term “hold process” refers to a sequence of server-side operations performed when a transaction or application is placed in a provisional state awaiting further confirmation, review, or additional information.

The term “reconfirmation process” refers to a sequence of server-side operations that requests additional confirmation or information from a user or another system component before a final approval state is set.

The term “service type” refers to a classification category for services provided by the system, such as customer support handling, transaction processing, or internal reporting.

The term “feedback message” refers to information generated by the server and provided to a user, including explanations of decisions, suggested next steps, or summaries of analysis.

The term “visualization data” refers to structured data prepared for graphical representation, such as coordinates, labels, and series data for charts or graphs.

The term “visualization information” refers to a representation of data in a graphical or chart format, including bar charts, line graphs, pie charts, or other visual forms suitable for display on a user terminal.

The term “electronic transaction request” refers to a data structure submitted by a user that requests execution of a financial or commercial transaction via an electronic communication network.

The term “application” refers to a data structure submitted by a user to request approval for an action, service, or resource, such as a grant, subscription change, or access permission.

The term “aggregated result data” refers to structured data representing combined statistics or summaries derived from multiple records, prepared for use as input to a generative AI model or for visualization.

The term “standardized prompt sentence” refers to a prompt sentence constructed according to a predefined template or format so that generative AI processing is consistent, repeatable, and easier to parse.

The term “machine-generated output” refers to data or text created by a generative AI model in response to a prompt sentence, as opposed to text directly authored by a human user.

In one embodiment, a server implements the claimed system as a network-accessible information processing apparatus that cooperates with one or more user terminals. The server comprises at least one hardware processor, a main memory, a non-volatile storage device, and a network interface, and executes a program stored in the non-volatile storage device to realize the functions described below. The terminal comprises a computing device such as a smartphone, tablet, or personal computer, including a processor, a memory, a display, and input devices such as a keyboard, touch panel, camera, and microphone. The user operates the terminal to submit text data and review results.

The server uses a general-purpose operating system, such as a Unix-like operating system, and application software implemented, for example, in a programming language such as Python. The server uses a web framework, such as a generic HTTP application framework, to expose application programming interfaces (APIs) to the terminals. The server further uses a natural language processing library, such as a library corresponding to spaCy or NLTK, and uses a numerical computation library and data analysis library, such as libraries corresponding to NumPy and pandas, to implement analysis functions. The server also uses a deep learning framework, such as a framework corresponding to TensorFlow or PyTorch, to implement an emotion analysis model. The server accesses a generative AI model, such as a large-scale neural language model provided as an external service, via a network API.

The terminal sends, to the server, text data and metadata including user identifiers, form types, timestamps, and device types using an HTTP protocol over a secure transport layer.

The terminal displays, to the user, responses and visualizations generated by the server. The user inputs free-text information in natural language, such as an inquiry, an internal report, an application, or an electronic transaction request, through an input form displayed on the terminal. The terminal may additionally capture behavior information such as typing speed and correction frequency, and environmental or sensor-derived information such as audio features or facial image features, subject to user consent and privacy constraints.

The server stores, in a relational database management system, the raw text data and associated metadata in records that include at least a text field, a user identifier field, a form type field, and processing state flags. The server defines data structures in which each record is associated with additional fields for important expressions, topic information, emotion label, emotion intensity, summary text, classification result, approval state, and analysis statistics. By structuring the data in this way, the server can avoid re-parsing the same text data for different purposes and can reference shared intermediate results across modules, thereby reducing computational redundancy and memory usage.

The server uses a natural language processing pipeline to analyze the text data. The server uses a tokenizer and a sentence segmenter of the natural language processing library to divide the text into tokens and sentences. The server uses a morphological analyzer to identify base forms and inflectional attributes of words. The server uses a part-of-speech tagger to label each token with a grammatical category and uses a syntactic parser to compute dependency relations. The server further uses rule-based and statistical methods to identify important expressions such as domain-specific key phrases, named entities, or noun phrases that are relevant to classification and routing. The server stores the resulting structures as serialized feature objects linked to each record, including token lists, part-of-speech tags, dependency trees, and lists of important expressions.

The server determines topic information for each piece of text data. The server can implement topic inference using one or more methods. In one variant, the server uses a supervised classifier that consumes TF-IDF vectors computed from tokenized text and outputs a topic label selected from a predefined topic set, such as “billing”, “delivery”, “product quality”, or “system error”. The server may implement this classifier using a linear classifier, such as logistic regression or a support vector machine, trained on labeled historical data. In another variant, the server uses a small neural network classifier, such as a feedforward network with one or more hidden layers and rectified linear activation functions, to map embedding vectors to topic labels. The server stores the topic label and a confidence score for each text record.

The server uses a generative AI model for several tasks by constructing structured prompt sentences. The server generates a prompt sentence for inappropriate-expression detection that embeds the original text and specifies the expected output format. The server may use, for example, the following prompt sentence:

“You are a content moderation engine. Check the following text and list all inappropriate, offensive, or prohibited expressions. Return the result as a JSON-style list of strings, without any additional explanation. Text: [user text]”

The server passes this prompt sentence and the user text to the generative AI model via an API request. Internally, the generative AI model is a large neural network, such as a transformer-based language model with multiple self-attention layers, feedforward layers, and layer normalization. The model has been pre-trained on large text corpora and may be fine-tuned for instruction following. The server sets parameters such as maximum response length, sampling temperature, and decoding strategy (for example, greedy decoding or beam search) to bias outputs toward deterministic JSON-style lists. The server parses the output list, identifies inappropriate expressions, and updates the record with a flag indicating the presence of such expressions and a list of detected terms. By controlling the prompt sentence format and decoding parameters, the server improves the stability and parseability of the output compared to ad hoc use of generative models, which contributes to reduced error rate in automated moderation.

The server uses a generative AI model to summarize long text data by generating a summarization-specific prompt sentence. The server may use, for example, the following prompt sentence:

“Summarize the following text in 2 or 3 concise sentences. Focus on the main problems and the main positive points. Do not include any information that is not present in the text. Text: [user text]”

The server sends this prompt sentence and the original text to the generative AI model and receives a summary text. The server stores the summary text in a separate field. Because the server reuses the same summary text for routing, aggregation, and user feedback, the server reduces the need to repeatedly process long original text, thereby reducing computation time and bandwidth usage in later stages. Moreover, by systematically specifying summarization conditions in the prompt sentence, the server obtains more consistent summary lengths and focuses than would be achieved by a human operator or a simpler extractive method.

The server estimates the user's emotional state using an emotion analysis model implemented on the server. The server constructs a feature vector for each record. The feature vector may include linguistic features extracted from text (such as sentiment scores derived from word embeddings, polarity indicators from sentiment lexicons, and syntactic patterns) and non-linguistic features (such as typing speed statistics, frequency of corrections, temporal intervals between keystrokes, and derived audio prosody features like pitch variance). The server inputs the feature vector into a neural network, such as a multi-layer perceptron with one or more hidden layers or a recurrent network. The network outputs an emotion label, selected from a predefined set such as calm, stressed, angry, or sad, and an emotion intensity score, for example, a scalar in a normalized range. The server trains this model in advance using supervised learning with labeled data. During training, the server uses a loss function, such as a cross-entropy loss for label prediction combined with a mean squared error loss for intensity regression, and updates model weights using an optimization algorithm such as stochastic gradient descent or Adam. Data augmentation techniques, such as noise injection into timing features or paraphrasing of text, can be used to improve model robustness.

The server determines a priority or urgency for each record based on the emotion label and intensity, in combination with the topic information. For example, the server may assign higher urgency to texts about safety, harassment, or system outage when the emotion intensity indicates high stress or anger. The server stores the priority level as an attribute used in scheduling and resource allocation. In this way, the server performs a technically distinct operation from human triage because it uses emotion labels derived from behavioral features not directly available to human reviewers and applies formal priority rules in the processing engine, thereby enabling consistent and rapid processing.

The server aggregates analysis results over many records. The server uses the data analysis library to group records by topic labels and compute, for each topic, occurrence frequencies, distributions of sentiment or evaluation (for example, positive, negative, neutral), and distributions of emotion labels. The server may also compute time-series statistics, such as daily or weekly counts and moving averages. The server stores aggregated result data as structured records in an analysis table. These aggregated data structures are used as inputs to a generative AI model for generating higher-level analytical reports and trend summaries.

The server uses a generative AI model to generate analytical reports and feedback based on aggregated analysis results. The server constructs a prompt sentence that embeds aggregated statistics and instructs the model to generate a structured report. The server may use, for example, the following prompt sentence:

“You are a data analyst. Based on the following aggregated statistics, write an executive summary in about 250 words. Describe the top three topics with the highest number of negative opinions, mention any topics with strong positive feedback, and recommend three concrete actions. Data: [aggregated statistics text]”

The server inputs this prompt sentence to the generative AI model and obtains a machine-generated summary. The server then stores or transmits the summary to administrative terminals. By integrating aggregations and generative reporting in this way, the server offloads computationally heavy narrative generation from human operators and standardizes the structure and coverage of analytic reports.

The server determines an approval state for electronic transaction requests or applications using a combination of rule-based checks and the generative AI model. The server first retrieves approval criteria information from a configuration repository. The server performs deterministic checks, such as numerical thresholds and mandatory field presence, using conventional algorithmic routines. For cases that are not clearly acceptable or clearly unacceptable, the server prepares a detailed prompt sentence including the criteria and the application text. For example, the server uses the following prompt sentence:

“You are an approval engine. Based on the approval criteria below and the application text, decide whether to APPROVE, REJECT, or HOLD the application. Always start your answer with exactly one of ‘APPROVE:’, ‘REJECT:’, or ‘HOLD:’. Then provide a short explanation (2-3 sentences). Approval criteria: [criteria text] Application text: [application text]” The server sends this prompt sentence to the generative AI model and inspects the leading token of the response to extract the recommended decision. The server then combines this recommendation with internal rule-based indicators and emotion information. For example, when the emotion intensity exceeds a threshold, the server may override an APPROVE recommendation to set a HOLD state and initiate a reconfirmation process with the user. When a REJECT recommendation is produced with low emotion intensity, the server may directly finalize a rejection without additional interactions. Because the decision is derived using a standardized prompt format, the server can reliably parse and log the decision and reasoning, enabling auditability and reproducibility.

The server generates feedback messages to the user using the generative AI model based on integrated analysis results for each record. The server collects, for a given request, the moderation result, the summary text, the topic information, the priority, the approval state, and the emotion label. The server constructs a prompt sentence that characterizes the required feedback tone and content. For example, the server uses the following prompt sentence: “You are a support assistant. Based on the following analysis data, create a polite and clear feedback message for the user. Explain any rejection or hold decisions and suggest specific next steps. Use simple language. Analysis data: [structured description of approval state, reasons, and emotion label]”

The server transmits the prompt sentence to the generative AI model and returns the generated feedback text to the terminal. Because the server passes a structured description rather than free-form logs, the generative AI model uses a focused context and produces consistent messages, and the server reduces network traffic by transmitting compact structured data instead of full raw texts.

The server generates visualization information for display on the terminal. The server reads aggregated analysis data, such as counts per topic and per emotion label, and constructs visualization data structures that specify axes, labels, colors, and data series. The server may use a charting library to render images or may send the structured visualization data to the terminal for client-side rendering. The terminal displays bar charts, line graphs, or pie charts to the user. In another embodiment, the server also controls refresh frequency and data compression strategies to reduce communication load when updating dashboards in near real time.

The system provides technical improvements over conventional systems in several ways. Because the server maintains intermediate NLP features and analysis results in shared data structures, the server avoids repeated parsing and re-analysis across independent modules, thereby improving processing throughput and reducing memory usage. Because the server standardizes interaction with the generative AI model through carefully designed prompt sentences, including explicit task descriptions and output formats, the server reduces the variance and ambiguity of the model's outputs, enabling reliable parsing and consistent downstream behavior. Because the server incorporates emotion analysis based on behavioral features and integrates emotion into priority and approval logic, the server can allocate computational resources and schedule tasks in a manner that optimizes responsiveness to high-risk or high-stress situations, thereby improving response latency for critical items without increasing overall load. These effects are not merely automation of human judgment but arise from specific data structures, neural architectures, and algorithmic rules that exploit machine-only features and interactions.

In a further embodiment, the server deploys the emotion analysis model and certain smaller NLP models locally on edge servers at or near the terminals, while reserving the larger generative AI model on a centralized or cloud-based system. In this configuration, the terminal or a nearby edge server performs initial feature extraction and emotion estimation, reducing the size of data transmitted to the central server and lowering communication latency. The central server then relies on compact feature vectors and summary text rather than full raw text, thereby reducing bandwidth consumption and improving scalability. In another embodiment, the server uses a different neural network architecture for emotion analysis, such as a transformer encoder that processes the token sequence of the text jointly with a sequence of timing features. The server can encode typing intervals as numerical tokens and feed them into an additional encoder layer, learning cross-modal interactions between textual content and timing behavior. The server may use a multi-task training objective that jointly predicts emotion labels and topic labels, improving generalization performance and reducing the number of separate models that must be maintained. In yet another embodiment, the server can dynamically adjust prompt sentences to optimize response quality. The server may maintain a history of generative AI outputs and associated quality metrics (such as parse success rate or human review override rate) and can tune prompt phrasing, parameter settings, or temperature values to maximize deterministic behavior and minimize post-processing errors. Because the server applies these adaptations in the program logic, users and terminals are abstracted from model details and benefit automatically from improved inference performance.

The terminal, in all embodiments, serves as an interface for the user to input text, review summaries, approval states, and feedback messages, and observe visualizations. The user interacts with the system by submitting various types of content through the terminal and by acting on the processing results. The combination of the server's structured NLP, emotion-aware prioritization, generative AI model integration via designed prompt sentences, and visualization enables a technically improved, end-to-end pipeline that enhances the speed, accuracy, and reliability of computerized text processing beyond conventional rule-based or manual systems.

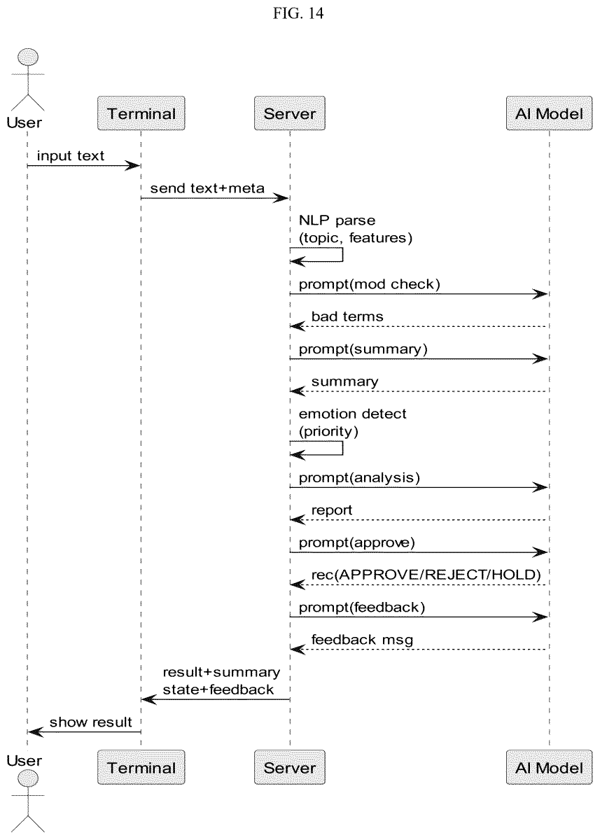

The following describes the processing flow using FIG. 14.

### Step 1:

User operates the terminal to input text data.

User opens an input screen on the terminal, such as a survey form, application form, transaction request screen, or internal report form, and types natural language text into one or more text fields. User may also select options, such as form type or category, and submits the form by activating a send operation. The input of this step is user-entered text and option values on the terminal UI. The output of this step is a structured set of form values held in the terminal's memory, including text content, selected options, and locally available metadata such as timestamp and device type.

### Step 2:

Terminal generates a request payload and transmits it to the server.

Terminal converts the form values into a data structure, such as a key-value map, and adds metadata including a user identifier, form type identifier, timestamp, and device information. Terminal serializes this structure into an HTTP request body, for example as a JSON string, and sends it to a server API endpoint over a secure network connection. The input of this step is the in-memory form data and metadata generated in Step 1. The output of this step is a transmitted network request that contains serialized text data and metadata destined for the server.

### Step 3:

Server receives the request and stores raw data.

Server accepts the network request at an API endpoint implemented by a web framework and parses the request body to reconstruct the text data and metadata into an internal object. Server validates required fields (such as user identifier, form type, and text content) and, if valid, creates a new record in a database table, storing the raw text, metadata, and an initial processing status. The input of this step is the serialized request payload received from the terminal. The output of this step is a persistent record that holds the raw text data, metadata, and initial state flags in the server's database.

### Step 4:

Server performs natural language preprocessing on the text data.

Server retrieves the newly stored record and passes the raw text field into a natural language processing pipeline that includes tokenization, sentence segmentation, morphological analysis, part-of-speech tagging, and syntactic parsing executed by a language processing library. Server then extracts linguistic features such as token lists, lemma forms, part-of-speech tags, and dependency relations, and identifies important expressions using rule-based filters or statistical thresholds. The input of this step is the raw text string from the database record. The output of this step is a feature object that includes structured linguistic information, which the server stores back into the record as preprocessed features.

### Step 5:

Server infers topic information from the preprocessed text.

Server converts the preprocessed features (for example, token count vectors or embedding vectors) into classifier-compatible input and applies a topic classification algorithm such as a linear classifier or neural network to assign one or more topic labels. Server may compute a confidence score for each label based on classifier outputs. The input of this step is the structured linguistic feature object produced in Step 4. The output of this step is a set of topic labels and corresponding scores, which the server writes to dedicated fields of the database record.

### Step 6:

Server generates a prompt sentence for inappropriate-expression detection and calls a generative AI model.

Server constructs a prompt sentence that embeds the original text and an instruction to list inappropriate or prohibited expressions, specifying the desired output format. For example, server may construct the following prompt sentence:

“You are a content moderation engine. Check the following text and list all inappropriate, offensive, or prohibited expressions. Return the result as a list of words only. Text: [user text]”

Server then sends this prompt sentence and the user text to a generative AI model via an API call, setting decoding parameters to encourage deterministic output. The input of this step is the raw text and a prompt template for moderation. The output of this step is a candidate list of inappropriate expressions returned by the generative AI model.

### Step 7:

Server parses moderation results and updates moderation flags.

Server receives the response from the generative AI model and parses it according to the expected list format, normalizing expression strings where necessary. Server determines whether any inappropriate expressions are present and sets a flag in the database record accordingly, optionally storing the list of expressions for later review. The input of this step is the text response from the generative AI model obtained in Step 6. The output of this step is an updated record with moderation flags and a stored list of detected inappropriate expressions.

### Step 8:

Server decides whether summarization is necessary and constructs a summarization prompt sentence.

Server measures the length of the original text, for example in characters or tokens, and compares the length with a threshold value. If the text exceeds the threshold, server determines that summarization is required and builds a summarization-specific prompt sentence that embeds the text and summarization instructions. For example, server may construct the following prompt sentence:

“Summarize the following text in 2 or 3 concise sentences. Focus on the main problems and the main positive points. Text: [user text]”

The input of this step is the raw text and a configuration that specifies length thresholds and summarization rules. The output of this step is a summarization prompt sentence ready for submission to the generative AI model, or a decision not to summarize if the threshold is not exceeded.

### Step 9:

Server calls the generative AI model to obtain summary text and stores the summary.

Server sends the summarization prompt sentence and the original text to the generative AI model, receives a shorter summary text as output, and writes this summary text into a dedicated field of the database record. If no summarization was required in Step 8, server may copy the original text or leave the summary field unused for that record. The input of this step is the summarization prompt sentence and the original text. The output of this step is a summary text of controlled length, stored in the database for use in downstream processing and display.

### Step 10:

Server extracts emotion-related features from text and behavioral data.

Server collects, for the current record, textual features such as sentiment scores, specific emotion-related keywords, and syntactic patterns, as well as behavioral metadata such as typing speed, correction frequency, or timing intervals if provided by the terminal. Server normalizes these numeric and categorical values into a fixed-length feature vector suitable for input to an emotion analysis model. The input of this step is the preprocessed linguistic features and any available behavioral or environmental metadata. The output of this step is a numerical feature vector representing the emotional cues associated with the text entry.

### Step 11:

Server estimates emotion label and emotion intensity using an emotion analysis model.

Server feeds the feature vector from Step 10 into an emotion analysis neural network that was pre-trained to predict emotion categories and intensity values. Server obtains an emotion label from a predefined set (such as calm, stressed, angry, or sad) and an emotion intensity score, typically a real-valued number within a bounded range. Server stores these values in the database record as emotion attributes. The input of this step is the emotion-related feature vector. The output of this step is an emotion label and intensity assigned to the record.

### Step 12:

Server determines processing priority or urgency based on emotion and topic information.

Server reads the emotion label and intensity along with the topic labels obtained earlier and evaluates these against priority rules stored in configuration data. Server calculates a priority level or urgency score, for example treating high-intensity negative emotions combined with certain topics (such as safety or harassment) as higher urgency. Server updates the record with this priority level, which will later influence scheduling and routing of processing. The input of this step is the emotion attributes and topic information stored for the record. The output of this step is a discrete or numeric priority value that guides internal processing order.

### Step 13:

Server aggregates analysis results across multiple records for statistical analysis.

Server periodically queries the database for groups of records, for example by form type or time range, and loads topic labels, sentiment-related attributes, and emotion labels into memory. Server uses data analysis functions to count occurrences per topic, compute ratios of positive, negative, and neutral evaluations, and derive distributions of emotion labels per topic. Server writes these aggregation results into summarized data structures such as topic-wise statistics records. The input of this step is a set of analysis attributes from many individual records. The output of this step is aggregated statistical data describing trends and distributions over the record set.

### Step 14:

Server constructs an analytical prompt sentence for the generative AI model based on aggregated data.

Server converts aggregated statistics into a textual description or a structured but textual representation and embeds this representation into a prompt sentence that instructs the generative AI model to produce an analytical summary. For example, server may construct the following prompt sentence:

“You are a data analyst. Based on the following statistics, write an executive summary in about 250 words. Explain which topics have the most negative feedback, which topics have positive feedback, and recommend three actions. Data: [aggregated statistics text]”

The input of this step is the aggregated statistical data and a prompt template for analysis.

The output of this step is a fully constructed analytical prompt sentence to be submitted to the generative AI model.

### Step 15:

Server requests an analytical report from the generative AI model and stores the result.

Server sends the analytical prompt sentence to the generative AI model, receives a narrative analytical report as output, and associates this report with the relevant group of records or with an administrative dashboard configuration. Server stores the report text in a report table for later retrieval by administrative users. The input of this step is the analytical prompt sentence generated in Step 14. The output of this step is a machine-generated analytic report text linked to the corresponding dataset.

### Step 16:

Server prepares an approval prompt sentence for electronic transaction requests or applications.

When a record corresponds to a transaction request or application, server fetches the applicable approval criteria from a configuration repository. Server then embeds the criteria and the request text into a decision-oriented prompt sentence instructing the generative AI model to output a categorical recommendation. For example, server may construct the following prompt sentence:

“You are an approval engine. Based on the approval criteria below and the application text, decide whether to APPROVE, REJECT, or HOLD. Always start your answer with exactly one of ‘APPROVE:’, ‘REJECT:’, or ‘HOLD:’. Then provide a short explanation. Approval criteria: [criteria text] Application text: [user text]”

The input of this step is the approval criteria and the application text associated with the record. The output of this step is a structured prompt sentence that captures both rules and content for the generative AI model.

### Step 17:

Server obtains a recommended approval decision from the generative AI model and interprets it.

Server sends the approval prompt sentence to the generative AI model and obtains a text response that begins with one of the keywords APPROVE, REJECT, or HOLD, followed by explanatory sentences. Server parses the first token or line to extract the recommended decision and splits the remainder as a rationale message. Server stores both the categorical recommendation and the explanatory text in dedicated fields of the record. The input of this step is the approval prompt sentence constructed in Step 16. The output of this step is a recommended decision and explanation generated by the generative AI model.

### Step 18:

Server computes a final approval state by combining rule-based checks, AI recommendation, and emotion information.

Server evaluates the rule-based validation results, the generative AI model recommendation, and the emotion attributes together. Server may, for example, require that a transaction be placed on hold when the emotion intensity exceeds a configured threshold, even if the model recommends approval, or may immediately reject if rule-based checks detect a violation regardless of the model output. Server applies these combined rules and sets the approval state field in the record to approved, rejected, or hold. The input of this step is the rule-based validation result, the AI recommendation, and the emotion attributes. The output of this step is the final approval state assigned to the record.

### Step 19:

Server generates a feedback prompt sentence and requests a user-facing feedback message from the generative AI model.

Server compiles all relevant analysis results for the record, including the moderation outcome, summary text, topic information, priority, final approval state, and emotion label. Server embeds these pieces into a feedback-oriented prompt sentence that specifies the required style and content. For example, server may construct the following prompt sentence: “You are a support assistant. Based on the following analysis data, create a polite and clear feedback message for the user. Explain any rejection or hold decisions and suggest specific next steps. Use simple language. Analysis data: [description of approval state, reasons, and emotion]”

The input of this step is the integrated analysis data for the record and a feedback prompt template. The output of this step is a feedback prompt sentence tailored to the particular case.

### Step 20:

Server obtains a feedback message from the generative AI model and returns it to the terminal.

Server sends the feedback prompt sentence to the generative AI model, receives a natural language feedback message, and attaches this message to the server response prepared for the user terminal. Server updates the record with the content of the feedback for logging purposes. The input of this step is the feedback prompt sentence produced in Step 19. The output of this step is a finalized feedback message that describes the decision and suggested next actions for the user.

### Step 21:

Server prepares visualization data and transmits results to the terminal.

Server reads summary fields, approval states, and priority values for the record, and may also access aggregated statistics for display. Server constructs a response payload that includes the feedback message, the summary text, the approval state, and, if requested, visualization data specifying chart elements. Server serializes this payload and sends it back to the terminal using the same API channel. The input of this step is the stored analysis results and graphical data structures associated with the record or group of records. The output of this step is a response payload containing textual and visual information for presentation.

### Step 22:

Terminal displays responses, visualizations, and guidance to the user.

Terminal receives the response payload from the server and parses it to extract the feedback message, summary text, approval state, and visualization data. Terminal renders text on the display in appropriate sections and generates visual graphics such as charts based on the provided visualization data. User views the displayed information and may choose to revise the original text, submit additional documents, confirm a transaction, or take other actions indicated by the feedback. The input of this step is the response payload received from the server. The output of this step is a human-readable screen on the terminal and, depending on user actions, new or updated input for subsequent processing cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

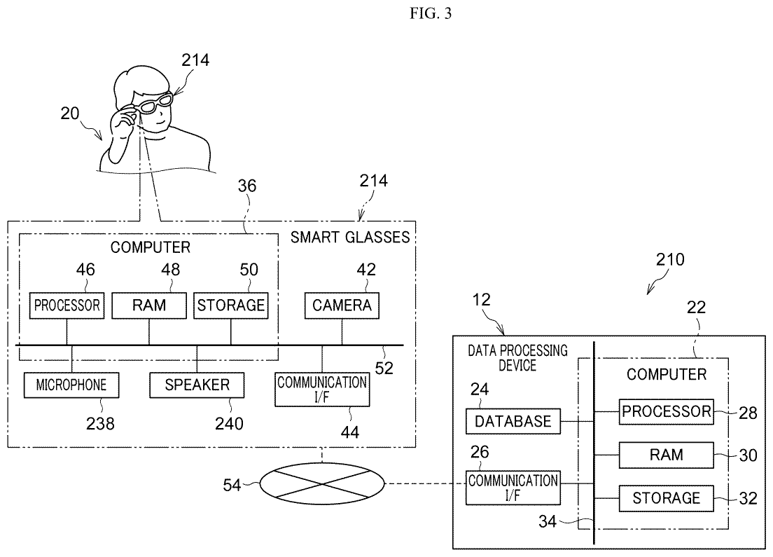

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

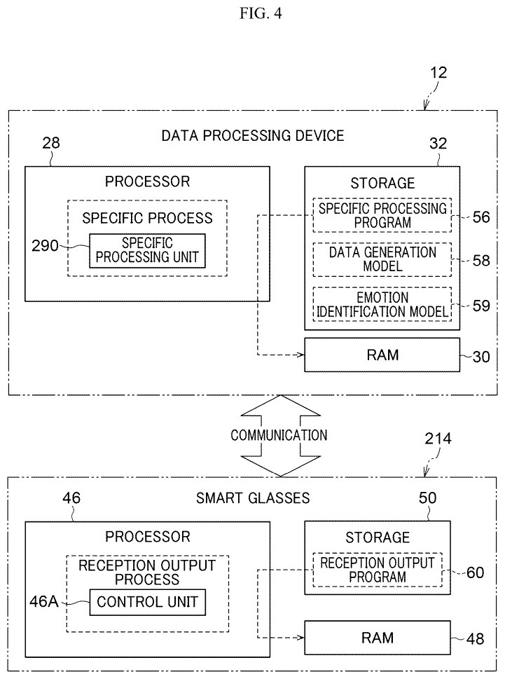

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

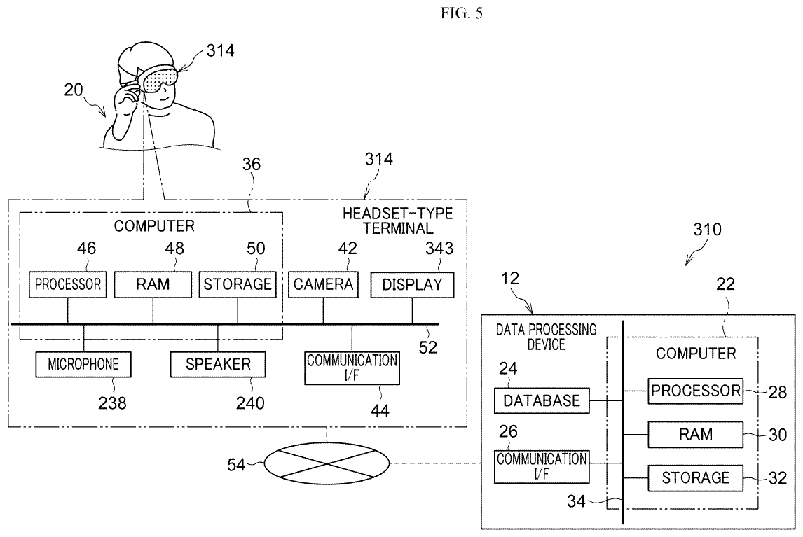

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

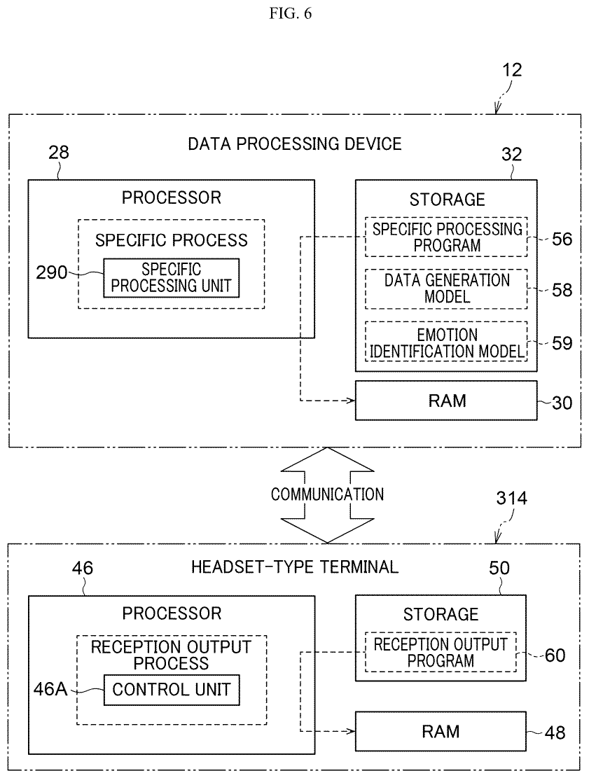

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

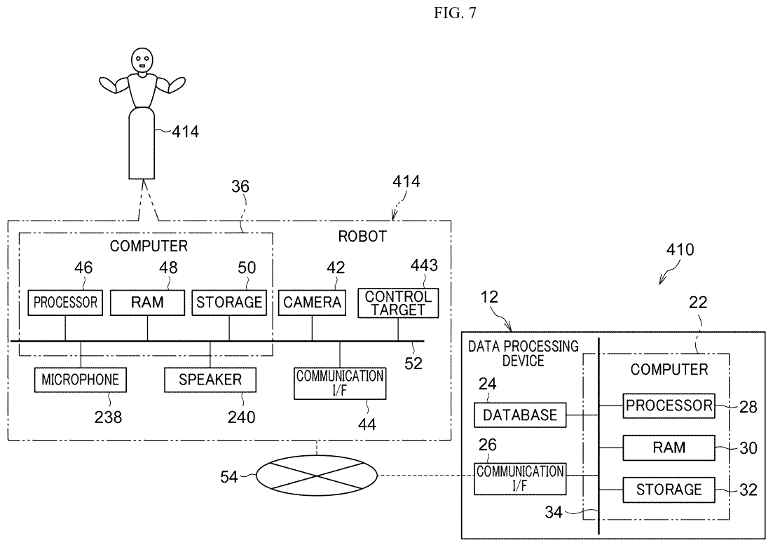

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

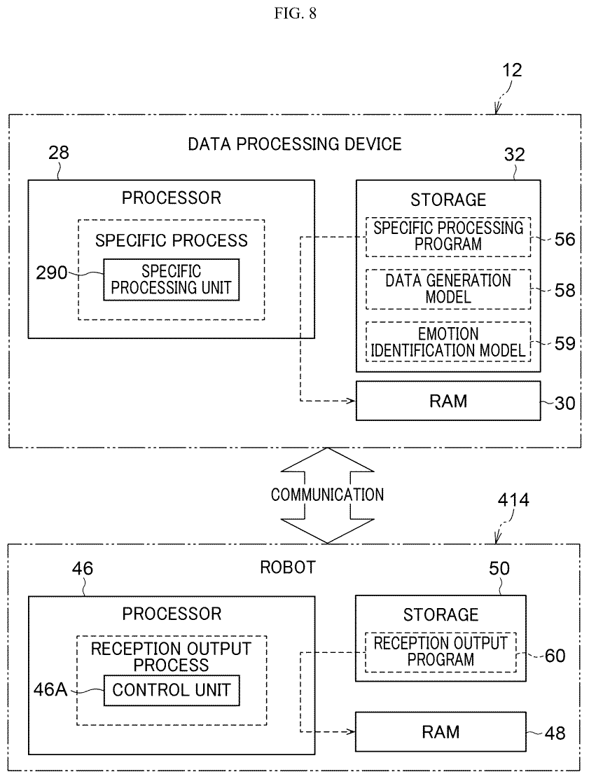

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

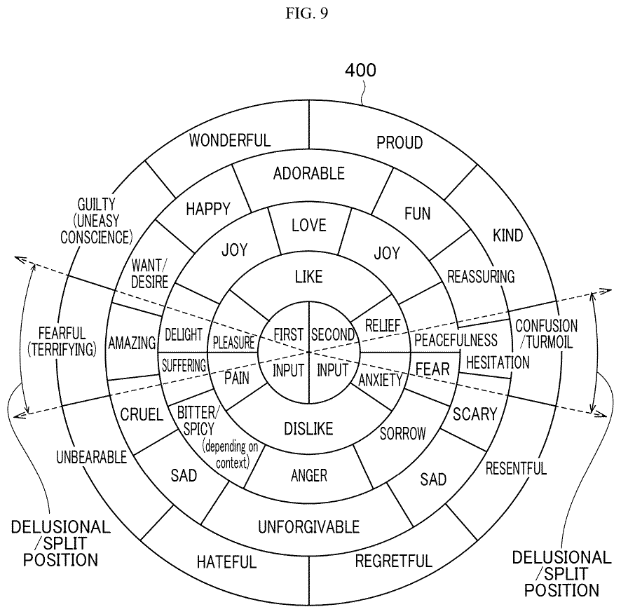

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

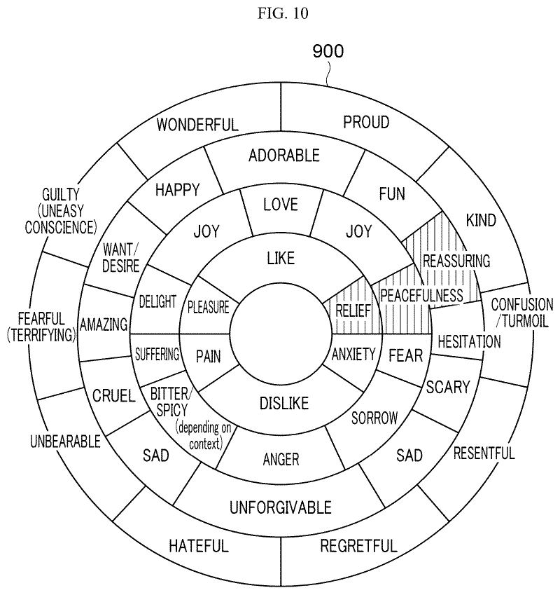

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive natural-language information transmitted from a user terminal, compute at least one of a character length and a word count of the information and determine, based on a computation result, whether the information is to be treated as a summarization target,
analyze, by using natural-language processing, expressions included in the information and extract important terms and expressions corresponding to predetermined criteria,
classify the information, based on the extracted expressions and contents of the information, into at least one of a functional category and a service category corresponding to an organizational unit or a processing service,
generate a prompt sentence including instruction content for confirmation of presence or absence of an inappropriate expression and the information, and input the prompt sentence to a generative information processing apparatus so as to instruct a generative AI model, as the generative information processing apparatus, to detect the inappropriate expression, when it is determined that the information is the summarization target, generate a prompt sentence including instruction content for summary generation and the information, and input the prompt sentence to the generative AI model so as to instruct the generative AI model to generate a summary of a long text,
analyze, based on contents of the information, an emotional state of a user and set a processing priority of the information according to an analysis result of the emotional state, automatically allocate the information, based on a classification result and the processing priority, to at least one of a processing service and a response service, generate a prompt sentence including instruction content for classification and feedback provision and at least one of the information and the classification result, and input the prompt sentence to the generative AI model so as to instruct the generative AI model to perform at least a validity evaluation of classification contents and generation of a feedback text for the user, and
generate warning information and summary information to be notified to the user terminal, based on at least one of an analysis result, an inappropriate expression detection result, and a summary result acquired from the generative AI model, and transmit the warning information and the summary information to the user terminal.

### (Supplementary 2)

The system according to supplementary 1,
wherein the processor is configured to
generate notification data including information for at least one of emphasis display and presentation of correction candidates for a portion of the information corresponding to an inappropriate expression, based on an inappropriate expression detection result acquired from the generative AI model, and transmit the notification data to the user terminal.

### (Supplementary 3)

The system according to supplementary 1,
wherein the processor is configured to dynamically change the prompt sentence to be input to the generative AI model in accordance with at least one of a type of the information, the classification result, and the processing priority, and switch instruction contents of the prompt sentence with respect to at least one of inappropriate expression detection, summary generation, and feedback provision.

### Application Example 1

### (Supplementary 1)

A system comprising a processor,
wherein the processor is configured to
receive, via a communication unit, text data input by a user from a terminal, preprocess character strings included in the text data by using a natural language processing technique, including performing character code normalization, removing whitespace characters, and unifying a format of the text data,
analyze contents of the text data by using the natural language processing technique to extract important terms and to determine whether the text data is long text based on at least one of a character count and a token count,
automatically route the text data to one of a plurality of processing categories or business divisions based on the extracted important terms and the analysis results,
generate a first prompt sentence that describes an analysis request including the text data as an instruction for detecting inappropriate expressions or erroneous information, and input the first prompt sentence to a generative artificial intelligence model,
obtain, from the generative artificial intelligence model, response data indicating at least one of presence or absence of an inappropriate expression, a specific example of the inappropriate expression, and an analysis result regarding information suspected to be an erroneous input, identify a problematic portion in the text data based on the response data, and transmit warning information corresponding to the problematic portion to the terminal,
when the text data is determined to be long text, generate a second prompt sentence that describes an instruction for generating a summary, input the second prompt sentence and the text data to the generative artificial intelligence model to obtain summary text, and transmit the obtained summary text to the terminal,
analyze an emotional state of the user based on expressions and terms extracted from the text data, and set a processing priority of the text data in accordance with the emotional state,
classify the text data into one of a plurality of service types based on at least one of the analysis results and the processing priority, generate a third prompt sentence that describes an instruction for generating feedback information including at least one of a guidance message and a correction candidate, input the third prompt sentence to the generative artificial intelligence model, and provide the obtained feedback information to the terminal in real time, and
perform control to repeatedly execute a series of processing including analysis, inappropriate expression detection, summary generation, priority setting, and feedback provision on corrected text data transmitted from the terminal.

### (Supplementary 2)

The system according to supplementary 1,
wherein the processor is configured to
analyze the contents of the text data by the natural language processing technique,
automatically determine a related business division or service type based on terms, expression patterns, and contextual information included in the text data, and correct a routing result of the text data by combining a determination result with the analysis result obtained from the generative artificial intelligence model.

### (Supplementary 3)

The system according to supplementary 1,
wherein the processor is configured to numerically represent or categorize the emotional state of the user from the text data by using an emotion analysis technique, change at least one of contents and parameters of a prompt sentence to be input to the generative artificial intelligence model in accordance with the emotional state, and preferentially control at least one of a processing order and a notification method for the text data.

### Example 2

### (Supplementary 1)

A system comprising a processor,
wherein the processor is configured to
receive structured information or unstructured information from a user via a communication terminal and store the received information in a data storage area,
convert the received information into tabular data and perform preprocessing including missing-value completion, removal of unnecessary symbols, unification of character types, and integration of multiple items to generate analysis data,
perform language analysis processing on natural language text included in the analysis data, the language analysis processing including morphological analysis, part-of-speech tagging, and phrase segmentation, and extract features,
classify the information automatically into predetermined themes or classification items by using a statistical learning model or a machine learning model based on the extracted features,
evaluate a confidence level of the automatic classification, extract information having the confidence level below a threshold, generate an input sentence including a prompt sentence that instructs a generative AI model to perform theme classification or classification-result correction, and update the classification result based on a response from the generative AI model,
generate an input sentence including a prompt sentence for detecting presence or absence of inappropriate expressions or negative intent in expressions included in the information, provide the input sentence to the generative AI model, and determine the inappropriate expressions based on a response obtained from the generative AI model,
generate an input sentence including a prompt sentence for summary generation for an entire text of the information and acquire summary information based on a response from the generative AI model,
analyze an emotional state of the information by using an emotion analysis technique, calculate a processing priority of the information according to emotional polarity or emotional intensity, and sort the classified information in order of priority based on the processing priority,
associate the information with a service type or a business type based on a classification result, an emotion analysis result, and the summary information or feedback information generated by the generative AI model, and convert an association result and statistical information into visualization data to generate an output data structure, and
generate graphical information or list information indicating a number of cases by classification, a ratio by emotion, a time-series trend, and representative opinions based on the output data structure, and transmit the graphical information or the list information to the communication terminal for presentation to the user.

### (Supplementary 2)

The system according to supplementary 1,
wherein the processor is configured to
aggregate the classification result and the emotion analysis result, perform aggregation processing by theme, by emotion, and by time unit, automatically detect a theme or a classification item having an abnormal trend or an increasing trend based on a result of the aggregation processing, and emphasize the theme or the classification item in the visualization data.

### (Supplementary 3)

The system according to supplementary 1,
wherein the processor is configured to
receive correction operations by the user for the classification result and the emotion analysis result, store correction results as training records, and reflect the training records in retraining of the statistical learning model or the machine learning model so as to improve accuracy of subsequent classification processing or emotion analysis processing.

### Application Example 2

### (Supplementary 1)

A system comprising a processor,
wherein the processor is configured to
receive text data and metadata transmitted from a user terminal,
perform natural language processing on the received text data, the natural language processing including at least morphological analysis, part-of-speech tagging, and syntactic parsing, and extract important expressions and topic information from the text data,
automatically sort the text data into organizational units or processing-responsible units based on the extracted important expressions and topic information in accordance with predetermined classification rules,
generate a prompt sentence including the text data in order to check whether the text data includes inappropriate expressions, input the prompt sentence into an external generative AI model, and obtain presence-or-absence information of inappropriate expressions and a list of corresponding expressions,
generate a prompt sentence including summarization conditions for summarizing long text data, input the prompt sentence and the text data into the generative AI model, and obtain summary text,
input the text data and feature information including at least user input behavior information or environment information into an emotion analysis model, and obtain an emotion label and emotion intensity that represent a user's emotional state,
determine a priority or urgency of the text data based on the obtained emotion label and emotion intensity,
aggregate, for a plurality of pieces of text data, the topic information, the emotion label, and the summary text, and calculate, by an analysis unit, occurrence frequency, evaluation tendency, and emotion distribution for each topic,
generate a prompt sentence including analysis results calculated by the analysis unit as input data, input the prompt sentence into the generative AI model, and obtain response text including at least trend reports by topic, proposals of approval or rejection, and feedback messages for the user,
classify information into predetermined service types or processing flows based on the response text and the analysis results, and output processing results and feedback corresponding to the service types or processing flows to the user terminal,
generate visualization data based on the analysis results, and output visualization information in a graph or chart format,
generate a prompt sentence including approval criteria information defined in advance, the text data, and the analysis results for an electronic transaction request or an application, input the prompt sentence into the generative AI model, obtain determination information indicating at least one of approval, rejection, and hold, and determine an approval state based on the determination information, and
select and execute, in accordance with the approval state and the user's emotional state, at least one of an approval process, a hold process, and a reconfirmation process.

### (Supplementary 2)

The system according to supplementary 1,
wherein the processor is configured to aggregate the text data by topic and by emotion based on the topic information and the emotion label, calculate occurrence tendencies of positive opinions, negative opinions, and neutral opinions for each topic, and generate aggregated result data to be input to the generative AI model.

### (Supplementary 3)

The system according to supplementary 1,
wherein the processor is configured to evaluate, in determining the approval state, the determination information from the generative AI model with respect to the approval criteria information and the emotion label and the emotion intensity from the emotion analysis model in combination, and set a transaction or an application corresponding to the text data to a hold state when the emotion intensity exceeds a predetermined threshold.

What is claimed is:

1. A system comprising:
circuitry configured to:
receive, via a communication interface coupled to a packet-switched network, natural-language information transmitted from a user terminal, and compute at least one of a character length and a word count of the natural-language information to determine whether the natural-language information is to be treated as a summarization target;
analyze expressions included in the natural-language information using a natural language processing technique, extract important terms and expressions corresponding to predetermined criteria, and classify the natural-language information based on the extracted expressions and contents of the natural-language information into at least one of a functional category and a service category;
generate a first prompt sentence comprising instruction content for confirmation of presence or absence of an inappropriate expression and the natural-language information, input the first prompt sentence to a generative AI model to instruct detection of the inappropriate expression, and when it is determined that the natural-language information is the summarization target, generate a second prompt sentence comprising instruction content for summary generation and input the second prompt sentence to the generative AI model to generate a summary;
analyze, based on contents of the natural-language information, an emotional state of a user and set a processing priority of the natural-language information according to an analysis result of the emotional state, and automatically allocate the natural-language information based on a classification result and the processing priority to at least one of a processing service and a response service; and
generate a third prompt sentence comprising instruction content for classification and feedback provision and at least one of the natural-language information and the classification result, input the third prompt sentence to the generative AI model to instruct validity evaluation of classification contents and generation of a feedback text, and transmit warning information and summary information to the user terminal via the communication interface.

2. The system according to claim 1, wherein the circuitry is configured to
generate notification data comprising information for at least one of emphasis display and presentation of correction candidates for a portion of the natural-language information corresponding to an inappropriate expression, based on an inappropriate expression detection result acquired from the generative AI model, and transmit the notification data to the user terminal.

3. The system according to claim 2, wherein the circuitry is configured to
identify a problematic portion in the natural-language information based on the inappropriate expression detection result, and transmit warning information corresponding to the problematic portion to the user terminal.

4. The system according to claim 3, wherein the circuitry is configured to
dynamically change at least one of the first prompt sentence, the second prompt sentence, and the third prompt sentence in accordance with at least one of a type of the natural-language information, the classification result, and the processing priority, and switch instruction content with respect to at least one of inappropriate expression detection, summary generation, and feedback provision.

5. The system according to claim 4, wherein the circuitry is configured to
include, in the third prompt sentence, instruction content that instructs the generative AI model to generate feedback text with a tone and level of detail adapted to the classification result and the processing priority.

6. The system according to claim 1, wherein the natural language processing technique applied to the natural-language information comprises tokenization, character code normalization, whitespace removal, and format unification of the natural-language information prior to expression extraction.

7. The system according to claim 6, wherein the circuitry is configured to
apply named entity recognition and dependency parsing to the normalized natural-language information to identify and extract the important terms as structured fields comprising at least a topic category and an intent indicator.

8. The system according to claim 1, wherein the circuitry is configured to
apply an emotion analysis model to the natural-language information to generate an emotion score, map the emotion score to a priority level from a predefined priority scale, and set the processing priority of the natural-language information based on the mapped priority level.

9. The system according to claim 8, wherein the emotion analysis model applies a trained sentiment classifier to a token representation of the natural-language information to generate the emotion score as a multi-dimensional vector comprising at least a valence component and an arousal component.

10. The system according to claim 1, wherein the classification of the natural-language information into the functional category and the service category is performed by applying a trained text classification model to the extracted expressions and a feature vector derived from the natural-language information.

11. The system according to claim 10, wherein the trained text classification model is retrained using records stored in the memory comprising prior natural-language information inputs, classification results, and user feedback on classification accuracy.

12. The system according to claim 1, wherein the circuitry is configured to
determine that the natural-language information is the summarization target when the computed character length exceeds a predetermined character threshold or the computed word count exceeds a predetermined word count threshold.

13. The system according to claim 1, wherein the second prompt sentence comprises instruction content specifying a maximum summary length and a summary format type, and the summary generated by the generative AI model conforms to the specified maximum summary length and format type.

14. The system according to claim 1, wherein the circuitry is configured to
store the natural-language information, the classification result, the processing priority, and the feedback text in a log record in the memory, and update the log record with a processing completion timestamp after transmission to the processing service or response service.

15. The system according to claim 14, wherein the circuitry is configured to
aggregate log records over a predetermined time window, compute statistical metrics comprising average processing priority, classification distribution, and inappropriate expression detection rate, and generate a performance summary for presentation to an operator terminal.

16. The system according to claim 1, wherein the circuitry is configured to
generate a response confirmation request comprising the feedback text generated by the generative AI model and transmit the response confirmation request to an operator terminal before transmitting the feedback text to the user terminal.

17. The system according to claim 16, wherein the circuitry is configured to
receive an approval or modification from the operator terminal in response to the response confirmation request, and transmit the approved or modified feedback text to the user terminal via the communication interface.

18. A system comprising:
circuitry configured to:
receive natural-language information from a user terminal via a communication interface, compute a character length or word count to determine whether the natural-language information is a summarization target, and apply a natural language processing technique to extract important terms and classify the natural-language information into a functional category or service category;
generate a first prompt sentence for inappropriate expression detection and a second prompt sentence for summary generation when the natural-language information is a summarization target, and input each prompt sentence to a generative AI model;
analyze an emotional state of the user based on the natural-language information, set a processing priority based on the emotional state, and allocate the natural-language information to a processing service based on the classification result and the processing priority; and
generate a third prompt sentence for classification validity evaluation and feedback text generation, input the third prompt sentence to the generative AI model, and transmit warning information and summary information to the user terminal based on responses from the generative AI model.

19. The system according to claim 18, wherein the circuitry is configured to
dynamically adjust at least one of the first prompt sentence, the second prompt sentence, and the third prompt sentence based on the type of the natural-language information, the classification result, and the processing priority.

20. A method comprising:
receiving, via a communication interface coupled to a packet-switched network, natural-language information transmitted from a user terminal, and computing at least one of a character length and a word count of the natural-language information to determine whether the natural-language information is to be treated as a summarization target;
analyzing expressions included in the natural-language information using a natural language processing technique, extracting important terms and expressions corresponding to predetermined criteria, and classifying the natural-language information based on the extracted expressions and contents of the natural-language information into at least one of a functional category and a service category;
generating a first prompt sentence comprising instruction content for confirmation of presence or absence of an inappropriate expression and the natural-language information, inputting the first prompt sentence to a generative AI model to instruct detection of the inappropriate expression, and when it is determined that the natural-language information is the summarization target, generating a second prompt sentence comprising instruction content for summary generation and inputting the second prompt sentence to the generative AI model to generate a summary;
analyzing, based on contents of the natural-language information, an emotional state of a user and setting a processing priority of the natural-language information according to an analysis result of the emotional state, and automatically allocating the natural-language information based on a classification result and the processing priority to at least one of a processing service and a response service; and
generating a third prompt sentence comprising instruction content for classification and feedback provision and at least one of the natural-language information and the classification result, inputting the third prompt sentence to the generative AI model to instruct validity evaluation of classification contents and generation of a feedback text, and transmitting warning information and summary information to the user terminal via the communication interface.
